(19) United States
(12) Patent Application Publication
(10) Pub. No.: US 2022/0298339 A1
(43) Pub. Date: Sep. 22, 2022

(54) Crosslinkable Polymeric Composition and Coated Conductor

(71) Applicant: DOW GLOBAL TECHNOLOGIES LLC, Midland, MI (US)

(72) Inventors: Weiyi Wang, Shanghai (CN); Renhua Fan, Shanghai (CN); Hongyu Chen, Shanghai (CN); Yabin Sun, Shanghai (CN); Dachao Li, Collegeville, PA (US); Jeffrey M. Cogen, Collegeville, PA (US)

(21) Appl. No.: 17/639,709

(22) PCT Filed: Sep. 6, 2019
(86) PCT No.: PCT/CN2019/104650

§ 371 Date: Mar. 2, 2022

(51) Int. Cl. C08L 23/08; H01B 3/44; C08J 3/24; C08J 3/22

(52) U.S. Cl. CPC C08L 23/0892; H01B 3/448; C08J 3/24; C08J 3/22; C08J 2323/08; C08L 2310/00

(57) ABSTRACT

Provided is a composition, which contains (A) a silane functionalized ethylene-based polymer, (B) a hindered phenol antioxidant, and (C) an aromatic amine-aromatic sulfonic acid salt. A coated conductor including a conductor and a coating which contains said composition on the conductor is also provided.

### BACKGROUND

Cables are frequently formed by coating a conductor with a crosslinkable coating containing a polyolefin and hindered phenol antioxidant. To facilitate a moisture cure reaction, acids such as sulfonic acid are included in the coating. However, sulfonic acid is known to cause decomposition of the hindered phenol antioxidants. Decomposition of hindered phenol antioxidants is problematic because it generates isobutylene, which is toxic.

The art recognizes the need for a coating composition containing a polyolefin and hindered phenol antioxidant that is crosslinkable via a moisture cure reaction, and avoids the decomposition of the hindered phenol antioxidant.

### SUMMARY

The present disclosure provides a composition. The composition contains (A) a silane functionalized ethylene-based polymer, (B) a hindered phenol antioxidant, and (C) an aromatic amine-aromatic sulfonic acid salt.

The present disclosure also provides a process for moisture curing a silane functionalized ethylene-based polymer. The process includes (A) providing an aromatic amine-aromatic sulfonic acid salt; (B) mixing the aromatic amine-aromatic sulfonic acid salt with a hindered phenol antioxidant to form a catalyst composition; (C) contacting a silane functionalized ethylene-based polymer with the catalyst composition to form a crosslinkable composition; and (D) exposing the crosslinkable composition to moisture cure conditions to form a crosslinked composition.

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent US version is so incorporated by reference) especially with respect to the disclosure of definitions (to the extent not inconsistent with any definitions specifically provided in this disclosure) and general knowledge in the art.

The numerical ranges disclosed herein include all values from, and including, the lower and upper value. For ranges containing explicit values (e.g., a range from 1, or 2, or 3 to 5, or 6, or 7), any subrange between any two explicit values is included (e.g., the range 1-7 above includes subranges 1 to 2; 2 to 6; 5 to 7; 3 to 7; 5 to 6; etc.).

Unless stated to the contrary, implicit from the context, or customary in the art, all parts and percents are based on weight and all test methods are current as of the filing date of this disclosure.

“Alkoxy” (or “alkoxy group”) refers to the —OZ¹ radical, where representative Z¹ include alkyl, substituted alkyl, cycloalkyl, substituted cycloalkyl, heterocycloalkyl, substituted heterocycloalkyl, silyl groups and combinations thereof. Nonlimiting examples of suitable alkoxy radicals include methoxy, ethoxy, benzyloxy, and t-butoxy.

“Alkyl” and “alkyl group” refer to a saturated linear, cyclic, or branched hydrocarbon group. “Substituted alkyl,” refers to an alkyl in which one or more hydrogen atom bound to any carbon of the alkyl is replaced by another group such as a halogen, aryl, substituted aryl, cycloalkyl, substituted cycloalkyl, heterocycloalkyl, substituted heterocycloalkyl, halogen, haloalkyl, hydroxy, amino, phosphido, alkoxy, amino, thio, nitro, and combinations thereof.

“Ambient environment” refers to a condition of room temperature (23-25° C.) and 50% relative humidity.

“Antioxidant” refers to types or classes of chemical compounds that are capable of being used to minimize the oxidation that can occur during the processing of polymers.

“Aryl” and “aryl group” refer to an organic radical derived from aromatic hydrocarbon by deleting one hydrogen atom therefrom. An aryl group may be a monocyclic and/or fused ring system, each ring of which suitably contains from 5 to 7, preferably from 5 or 6 atoms. Structures wherein two or more aryl groups are combined through single bond(s) are also included. Specific examples include, but are not limited to, phenyl, tolyl, naphthyl, biphenyl, anthryl, indenyl, fluorenyl, benzofluorenyl, phenanthryl, triphenylenyl, pyrenyl, perylenyl, chrysenyl, napthacenyl, fluoranthenyl and the like. “Substituted aryl” refers to an aryl in which one or more hydrogen atom bound to any carbon is replaced by one or more functional groups such as alkyl, substituted alkyl, cycloalkyl, substituted cycloalkyl, heterocycloalkyl, substituted heterocycloalkyl, halogen, alkylhalos (e.g., CF₃), hydroxy, amino, phosphido, alkoxy, amino, thio, nitro, and both saturated and unsaturated cyclic hydrocarbons which are fused to the aromatic ring(s), linked covalently or linked to a common group such as a methylene or ethylene moiety. The common linking group may also be a carbonyl as in benzophenone or oxygen as in diphenylether or nitrogen in diphenylamine.

“Alpha-olefin,” “α-olefin” and like terms refer to a hydrocarbon molecule or a substituted hydrocarbon molecule (i.e., a hydrocarbon molecule comprising one or more atoms other than hydrogen and carbon, e.g., halogen, oxygen, nitrogen, etc.), the hydrocarbon molecule comprising (i) only one ethylenic unsaturation, this unsaturation located between the first and second carbon atoms, and (ii) at least 2 carbon atoms, or 3 to 20 carbon atoms, or 4 to 10 carbon atoms, or 4 to 8 carbon atoms. Nonlimiting examples of α-olefins include ethylene, propylene, 1-butene, 1-pentene, 1-hexene, 1-octene, 1-dodecene, and mixtures of two or more of these monomers.

“Blend,” “polymer blend” and like terms refer to a composition of two or more polymers. Such a blend mayor may not be miscible. Such a blend may or may not be phase separated. Such a blend may or may not contain one or more domain configurations, as determined from transmission electron spectroscopy, light scattering, x-ray scattering, and any other method used to measure and/or identify domain configurations.

The term “block copolymer” or “segmented copolymer” refers to a polymer comprising two or more chemically distinct regions or segments (referred to as “blocks”) joined in a linear manner, that is, a polymer comprising chemically differentiated units which are joined (covalently bonded) end-to-end with respect to polymerized functionality, rather than in pendent or grafted fashion. In an embodiment, the blocks differ in the amount or type of comonomer incorporated therein, the density, the amount of crystallinity, the type of crystallinity (e.g. polyethylene versus polypropylene), the crystallite size attributable to a polymer of such composition, the type or degree of tacticity (isotactic or syndiotactic), regio-regularity or regio-irregularity, the amount of branching, including long chain branching or hyper-branching, the homogeneity, or any other chemical or physical property.

A “cable” is at least one conductor, e.g., wire, optical fiber, etc., within a protective insulation, jacket, sheath. A cable may be two or more wires or two or more optical fibers bound together in a common protective jacket or sheath. Combination cables may contain both electrical wires and optical fibers. The individual wires or fibers inside the jacket or sheath may be bare, covered or insulated. The cable can be designed for low, medium, and/or high voltage applications.

The term “composition” refers to a mixture of materials which comprise the composition, as well as reaction products and decomposition products formed from the materials of the composition.

The terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually, as well as in any combination. Use of the singular includes use of the plural and vice versa.

A “conductor” is one or more wire(s), or one or more fiber(s), for conducting heat, light, and/or electricity at any voltage (DC, AC, or transient). The conductor may be a single-wire/fiber or a multi-wire/fiber and may be in strand form or in tubular form. Nonlimiting examples of suitable conductors include carbon and various metals, such as silver, gold, copper, and aluminum. The conductor may also be optical fiber made from either glass or plastic. The conductor may or may not be disposed in a protective sheath. The conductor may be a single cable or a plurality of cables bound together (i.e., a cable core, or a core).

“Crosslinkable” and “curable” indicate that the polymer, before or after shaped into an article, is not cured or crosslinked and has not been subjected or exposed to treatment that has induced substantial crosslinking although the polymer comprises additive(s) or functionality that will effectuate substantial crosslinking upon subjection or exposure to such treatment (e.g., exposure to water).

“Crosslinked” and similar terms indicate that the polymer composition, before or after it is shaped into an article, has xylene or decalin extractables of less than or equal to 90 weight percent (i.e., greater than or equal to 10 weight percent gel content).

“Cured” and similar terms indicate that the polymer, before or after it is shaped into an article, was subjected or exposed to a treatment which induced crosslinking.

An “ethylene-based polymer” is a polymer that contains more than 50 weight percent polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Nonlimiting examples of ethylene-based polymer (polyethylene) include low density polyethylene (LDPE), medium density polyethylene (MDPE), and linear polyethylene. Nonlimiting examples of linear polyethylene include linear low density polyethylene (LLDPE), ultra low density polyethylene (ULDPE), very low density polyethylene (VLDPE), multi-component ethylene-based copolymer (EPE), ethylene/α-olefin multi-block copolymers (also known as olefin block copolymer (OBC)), single-site catalyzed linear low density polyethylene (m-LLDPE), substantially linear, or linear, plastomers/elastomers, and high density polyethylene (HDPE). Generally, polyethylene may be produced in gas-phase, fluidized bed reactors, liquid phase slurry process reactors, or liquid phase solution process reactors, using a heterogeneous catalyst system, such as Ziegler-Natta catalyst, a homogeneous catalyst system, comprising Group 4 transition metals and ligand structures such as metallocene, non-metallocene metal-centered, heteroaryl, heterovalent aryloxyether, phosphinimine, and others. Combinations of heterogeneous and/or homogeneous catalysts also may be used in either single reactor or dual reactor configurations. In an embodiment, the ethylene-based polymer does not contain an aromatic comonomer polymerized therein.

“Ethylene plastomers/elastomers” are substantially linear, or linear, ethylene/α-olefin copolymers containing homogeneous short-chain branching distribution comprising units derived from ethylene and units derived from at least one C₃-C₁₀ α-olefin comonomer. Ethylene plastomers/elastomers have a density from 0.870 g/cc to 0.917 g/cc. Nonlimiting examples of ethylene plastomers/elastomers include AFFINITY™ plastomers and elastomers (available from The Dow Chemical Company), EXACT™ Plastomers (available from ExxonMobil Chemical). Tafmer™ (available from Mitsui). Nexlene™ (available from SK Chemicals Co.), and Lucene™ (available from LG Chem Ltd.).

“High density polyethylene” (or “HDPE”) is an ethylene homopolymer or an ethylene/α-olefin copolymer with at least one C₄-C₁₀ α-olefin comonomer and a density from greater than 0.94 g/cc to 0.98 g/cc. The HDPE can be a monomodal copolymer or a multimodal copolymer. A “monomodal ethylene copolymer” is an ethylene/C₄-C₁₀α-olefin copolymer that has one distinct peak in a gel permeation chromatography (GPC) showing the molecular weight distribution A “multimodal ethylene copolymer” is an ethylene/C₄-C₁₀ α-olefin copolymer that has at least two distinct peaks in a GPC showing the molecular weight distribution. Multimodal includes copolymer having two peaks (bimodal) as well as copolymer having more than two peaks. Nonlimiting examples of HDPE include DOW™ High Density Polyethylene (HDPE) Resins, ELITE™ Enhanced Polyethylene Resins, and CONTINUUM™ Bimodal Polyethylene Resins, each available from The Dow Chemical Company; LUPOLEN™, available from LyondellBasell; and HDPE products from Borealis, Ineos, and ExxonMobil.

The terms “hydrocarbyl” and “hydrocarbon” refer to substituents containing only hydrogen and carbon atoms, including branched or unbranched, saturated or unsaturated, cyclic, polycyclic or noncyclic species. Nonlimiting examples include alkyl-, cycloalkyl-, alkenyl-, alkadienyl-, cycloalkenyl-, cycloalkadienyl-, aryl-, and alkynyl- groups.

A “hydrolysable silane group” is a silane group that will react with water. These include alkoxysilane groups on monomers or polymers that can hydrolyze to yield silanol groups, which in turn can condense to crosslink the monomers or polymers.

An “interpolymer” is a polymer prepared by the polymerization of at least two different monomers. This generic term includes copolymers, usually employed to refer to polymers prepared from two different monomers, and polymers prepared from more than two different monomers, e.g., terpolymers, tetrapolymers, etc.

A “jacket” is an outermost coating on the conductor. When the conductor includes a single coating, the coating may serve as both a jacket and an insulation on the conductor.

“Linear low density polyethylene” (or “LLDPE”) is a linear ethylene/α-olefin copolymer containing heterogeneous short-chain branching distribution comprising units derived from ethylene and units derived from at least one C₃-C₁₀ α-olefin comonomer. LLDPE is characterized by little, if any, long chain branching, in contrast to conventional LDPE. LLDPE has a density from 0.910 g/cc to 0.940 g/cc. Nonlimiting examples of LLDPE include TUFLIN™ linear low density polyethylene resins and DOWLEX™ polyethylene resins, each available from the Dow Chemical Company; and MARLEX™ polyethylene (available from Chevron Phillips).

“Low density polyethylene” (or “LDPE”) consists of ethylene homopolymer, or ethylene/α-olefin copolymer comprising at least one C₃-C₁₀α-olefin comonomer, that has a density from 0.915 g/cc to 0.940 g/cc and contains long chain branching with broad MWD. LDPE is typically produced by way of high pressure free radical polymerization (tubular reactor or autoclave with free radical initiator). Nonlimiting examples of LDPE include MarFlex™ (Chevron Phillips), LUPOLEN™ (LyondellBasell), as well as LDPE products from Borealis, Ineos, ExxonMobil, and others.

“Medium density polyethylene” (or “MDPE”) is an ethylene homopolymer, or an ethylene/α-olefin copolymer comprising at least one C₃-C₁₀ α-olefin comonomer, that has a density from 0.926 g/cc to 0.940 g/cc.

“Multi-component ethylene-based copolymer” (or “EPE”) comprises units derived from ethylene and units derived from at least one C₃-C₁₀α-olefin comonomer, such as described in patent references U.S. Pat. Nos. 6,111,023; 5,677,383; and 6,984,695. EPE resins have a density from 0.905 g/cc to 0.962 g/cc. Nonlimiting examples of EPE resins include ELITE™ enhanced polyethylene and ELITE AT™ advanced technology resins, each available from The Dow Chemical Company; SURPASS™ Polyethylene (PE) Resins, available from Nova Chemicals; and SMART™, available from SK Chemicals Co.

An “olefin-based polymer,” as used herein, is a polymer that contains more than 50 mole percent polymerized olefin monomer (based on total amount of polymerizable monomers), and optionally, may contain at least one comonomer. Nonlimiting examples of olefin-based polymer include ethylene-based polymer and propylene-based polymer.

A “polymer” is a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer, as described above, prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “propylene-based polymer” is a polymer that contains more than 50 mole percent polymerized propylene monomer (based on the total amount of polymerizable monomers) and, optionally, may contain at least one comonomer. Propylene-based polymer includes propylene homopolymer, and propylene copolymer (meaning units derived from propylene and one or more comonomers). The terms “propylene-based polymer” and “polypropylene” may be used interchangeably. A nonlimiting example of a propylene-based polymer (polypropylene) is a propylene/α-olefin copolymer with at least one C₂ or C₄-C₁₀ α-olefin comonomer.

A “sheath” is a generic term and when used in relation to cables, it includes insulation coverings or layers, protective jackets and the like.

“Single-site catalyzed linear low density polyethylenes” (or “m-LLDPE”) are linear ethylene/α-olefin copolymers containing homogeneous short-chain branching distribution comprising units derived from ethylene and units derived from at least one C₃-C₁₀α-olefin comonomer, m-LLDPE has density from 0.913 g/cc to 0.940 g/cc. Nonlimiting examples of m-LLDPE include EXCEED™ metallocene PE (available from ExxonMobil Chemical), LUFLEXEN™ m-LLDPE (available from LyondellBasell), and ELTEX™ PF m-LLDPE (available from Ineos Olefins & Polymers).

“Ultra low density polyethylene” (or “ULDPE”) and “very low density polyethylene” (or “VLDPE”) each is a linear ethylene/α-olefin copolymer containing heterogeneous short-chain branching distribution comprising units derived from ethylene and units derived from at least one C₃-C₁₀ α-olefin comonomer. ULDPE and VLDPE each has a density from 0.885 g/cc to 0.915 g/cc. Nonlimiting examples of ULDPE and VLDPE include ATTANE™ ULDPE resins and FLEXOMER™ VLDPE resins, each available from The Dow Chemical Company.

A “wire” is a single strand of conductive metal, e.g., copper or aluminum, or a single strand of optical fiber.

### Test Methods

Density is measured in accordance with ASTM D792, Method B. The result is recorded in grams (g) per cubic centimeter (g/cc or g/cm³).

Gel content is measured by extraction in boiling decalin at 180° C. for 5 hours according to ASTM 2765. The result is recorded in percent (%), based on the total weight of the composition. The percent gel normally increases with increasing crosslinking levels.

Hot creep is measured in accordance with IEC-60811-2-1. Thermal deformation at 200° C. is measured as a percentage (%) under a load of 0.2 MPa. Water bath hot creep is measured after a sample has been cured in a water bath at 90° C. for 1 hour, 3 hours, and 6 hours. Ambient environment hot creep is measured after a sample has been cured at room temperature (23-25° C.) and 50% relative humidity for 69 hours, 90 hours, 100 hours, 168 hours, and 230 hours.

Melt index (MI) (also known as I₂) is measured in accordance with ASTM D1238, Condition 190° C./2.16 kilogram (kg) weight and is reported in grams eluted per 10 minutes (g/10 min).

### Isobutylene Measurement

Samples are prepared for isobutylene measurements in accordance with two methods.

Sample Preparation Method 1. One gram of catalyst masterbatch pellets are sealed into a HSGC vial within 10 minutes of pelletization. The vial is sealed and stored at room temperature (23-25° C.) for two weeks. Then, isobutylene generation.

Sample Preparation Method 2. Catalyst masterbatch pellets are placed into a polyethylene bag within 10 minutes of pelletization. The bag is sealed and stored at room temperature (23-25° C.) for two weeks. Then, one gram of the sample is removed from the bag and placed into a HSGC vial, which is then sealed and measured for isobutylene generation.

Measurement. Isobutylene generated from a catalyst masterbatch is measured by (i) Headspace Gas Chromatography (HSGC) in accordance with the conditions of the below Table A, or (ii) Gas Chromatography (GC) in accordance with the conditions of the below Table B. In each case, the peak area at 1.8 minutes retention time is recorded.

TABLE A
HSGC Conditions

Instrument: Agilent 7697A Headspace Sampler

| | | |
|---|---|---|
| Oven: 50° C. | Multi HS Extr: Off | Shaking: Off |
| Loop: 70° C. | Transfer Line: 80° C. | Vial Equilibration: 30 min |
| Injection Duration: 0.5 min | Thermal Aux 1: 190° C. | GC Cycle: 8 min |

Instrument: Agilent 7890A Gas Chromatography system
Column: SOLGEL WAX column (30 m × 250 μm × 0.25 μm film)

| | | |
|---|---|---|
| Carrier Flow: | Oven: | Inlet: |
| 1.0 ml/min constant flow | 50° C., hold 5 min | Injector Temp: 220° C. |
| Helium carrier gas | Total run time: 5.0 min | Split Ratio: 1:20 |

| | |
|---|---|
| Injection: Headspace System | Detector: MSD |
| | MS Source Temperature: 230° C.; MS Quad Temperature: 150° C. |
| | Aux-2 Temperature: 280° C.; Acq. Mode: Scan Mass from 29 to 350 |

TABLE B
GC Conditions

Instrument: Agilent 7890A Gas Chromatography system
Column: DB-5MS column (30 m × 0.25 mm ID × 1.0 μm film)

| | | |
|---|---|---|
| Carrier Flow: | Oven: | Inlet: |
| 1.0 ml/min constant flow | 40° C., hold 5 min | Injector Temp: 200° C. |
| Helium carrier gas | Total run time: 5.0 min | Split Ratio: 1:5 |

| | |
|---|---|
| Injection: | Detector: MSD |
| Manual injection 100 μL | MS Source Temperature: 230° C.; MS Quad Temperature: 150° C. |
| | Aux-2 Temperature: 280° C.; Acq. Mode: Scan Mass from 29 to 350 |

### DETAILED DESCRIPTION

The present disclosure provides a composition. The composition contains (A) a silane functionalized ethylene-based polymer, (B) a hindered phenol antioxidant, and (C) an aromatic amine-aromatic sulfonic acid salt.

In an embodiment, the (C) aromatic amine-aromatic sulfonic acid salt has the following Structure (I):

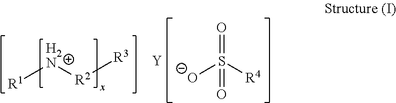

wherein Y is an integer from 1 to 2, or 3; R¹ is selected from an aryl group, a substituted aryl group, an alkyl group, or a substituted alkyl group; R² is selected from an aryl group, and a substituted aryl group; R³ is selected from an aryl group, a substituted aryl group, an alkyl group, a substituted alkyl group, or hydrogen; R⁴ is selected from an aryl group, and a substituted aryl group; and X is an integer from 1 to 2, or 3, or 4.

A. Silane Functionalized Ethylene-Based Polymer

The composition includes a silane functionalized ethylene-based polymer. A “silane functionalized ethylene-based polymer” is a polymer that contains silane and equal to or greater than 50 wt %, or a majority amount, of polymerized ethylene, based on the total weight of the polymer. Nonlimiting examples of suitable silane functionalized polyolefin include ethylene/silane copolymer, silane-grafted polyethylene (Si-g-PE), and combinations thereof.

An “ethylene/silane copolymer” is formed by the copolymerization of ethylene and a hydrolysable silane monomer (such as a vinyl alkoxysilane monomer). In an embodiment, the ethylene/silane copolymer is prepared by the copolymerization of ethylene, a hydrolysable silane monomer and, optionally, an unsaturated ester. The preparation of ethylene/silane copolymers is described, for example, in U.S. Pat. Nos. 3,225,018 and 4,574,133, each incorporated herein by reference.

A “silane-grafted polyethylene” (or “Si-g-PE”) is formed by grafting a hydrolysable silane monomer (such as a vinyl alkoxysilane monomer) onto the backbone of a base polyethylene. In an embodiment, grafting takes place in the presence of a free-radical generator, such as a peroxide. The hydrolysable silane monomer can be grafted to the backbone of the base polyethylene (i) prior to incorporating or compounding the Si-g-PE into a composition used to make a final article, such as a coated conductor (also known as a SIOPLAS™ process), or (ii) simultaneously with the extrusion of a composition to form a final article (also known as a MONOSIL™ process, in which the Si-g-PE is formed in situ during melt blending and extrusion). In an embodiment, the Si-g-PE is formed before the Si-g-PE is compounded with aromatic amine-aromatic sulfonic acid salt, hindered phenol antioxidant, and other optional components. In another embodiment, the Si-g-PE is formed in situ by compounding a polyethylene, hydrolysable silane monomer, and peroxide initiator, along with aromatic amine-aromatic sulfonic acid salt, hindered phenol antioxidant, and other optional components.

The base polyethylene for the Si-g-PE may be any ethylene-based polymer disclosed herein. Nonlimiting examples of suitable ethylene-based polymers include ethylene homopolymers and ethylene-based interpolymers containing one or more polymerizable comonomers, such as an unsaturated ester and/or an α-olefin. In an embodiment, the ethylene-based polymer is selected from a low density polyethylene (LDPE), a high density polyethylene (HDPE), and combination thereof.

The hydrolysable silane monomer used to make an ethylene/silane copolymer or a Si-g-PE is a silane-containing monomer that will effectively copolymerize with ethylene to form an ethylene/silane copolymer or graft to an ethylene-based polymer to form a Si-g-PE. Exemplary hydrolysable silane monomers are those having the following Structure (A):

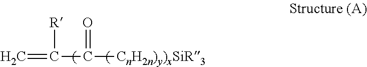

wherein R′ is a hydrogen atom or methyl group; x and y are 0 or 1 with the proviso that when x is 1, y is 1; n is an integer from 1 to 12 inclusive, or n is an integer from 1 to 4, and each R″ independently is a hydrolysable organic group such as an alkoxy group having from 1 to 12 carbon atoms (e.g., methoxy, ethoxy, butoxy), aryloxy group (e.g., phenoxy), aralkoxy group (e.g., benzyloxy), aliphatic acyloxy group having from 1 to 12 carbon atoms (e.g., formyloxy, acetyloxy, propanoyloxy), amino or substituted amino groups (alkylamino, arylamino), or a lower alkyl group having 1 to 6 carbon atoms inclusive, with the proviso that not more than one of the three R″ groups is an alkyl.

Nonlimiting examples of suitable hydrolysable silane monomers include silanes that have an ethylenically unsaturated hydrocarbyl group, such as vinyl, allyl, isopropenyl, butenyl, cyclohexenyl or gamma-(meth)acryloxy allyl group, and a hydrolysable group, such as, for example, a hydrocarbyloxy, hydrocarbonyloxy, or hydrocarbylamino group. Examples of hydrolysable groups include methoxy, ethoxy, formyloxy, acetoxy, propionyloxy, and alkyl or arylamino groups.

In an embodiment, the hydrolysable silane monomer is an unsaturated alkoxy silane such as vinyl trimethoxy silane (VTMS), vinyl triethoxy silane, vinyl triacetoxy silane, gamma-(meth)acryloxy, propyl trimethoxy silane, and mixtures of these silanes.

Nonlimiting examples of suitable unsaturated esters used to make an ethylene/silane copolymer include alkyl acrylate, alkyl methacrylate, or vinyl carboxylate. Nonlimiting examples of suitable alkyl groups include methyl, ethyl, n-propyl, i-propyl, n-butyl, t-butyl, etc. In an embodiment, the alkyl group has from 1, or 2 to 4, or 8 carbon atoms. Nonlimiting examples of suitable alkyl acrylates include ethyl acrylate, methyl acrylate, t-butyl acrylate, n-butyl acrylate, and 2-ethylhexyl acrylate. Nonlimiting examples of suitable alkyl methacrylates include methyl methacrylate and n-butyl methacrylate. In an embodiment, the carboxylate group has from 2 to 5, or 6, or 8 carbon atoms. Nonlimiting examples of suitable vinyl carboxylates include vinyl acetate, vinyl propionate, and vinyl butanoate.

In an embodiment, the silane functionalized ethylene-based polymer contains from 0.1 wt %, or 0.5 wt %, or 1.0 wt %, or 1.5 wt % to 2.0 wt %, or 2.5 wt % or 3.0 wt %, or 4.0 wt %, or 5.0 wt % silane, based on the total weight of the silane functionalized ethylene-based polymer.

In an embodiment, the silane functionalized ethylene-based polymer contains, consists essentially of or consists of: (i) from 50 wt %, or 60 wt %, or 70 wt %, or 80 wt %, or 90 wt %, or 95 wt % to 97 wt %, or 98 wt %, or 99 wt %, or less than 100 wt % ethylene; and (ii) a reciprocal amount of silane, or from greater than 0 wt %, or 1 wt %, or 2 wt %, or 3 wt %, to 5 wt %, or 10 wt %, or 20 wt %, or 30 wt %, or 40 wt %, or 50 wt % silane, based on the total weight of the silane functionalized ethylene-based polymer.

In an embodiment, the silane functionalized ethylene-based polymer has a density from 0.850 g/cc, or 0.910 g/cc, or 0.920 g/cc to 0.922 g/cc, 0.925 g/cc, or 0.930 g/cc, or 0.950 g/cc, or 0.965 g/cc. In another embodiment, the silane functionalized ethylene-based polymer has a density from 0.850 g/cc to 0.965 g/cc, or from 0.900 g/cc to 0.950 g/cc, or from 0.920 g/cc to 0.925 g/cc.

In an embodiment, the silane functionalized ethylene-based polymer has a melt index (MI) from 0.1 g/10 min, or 0.5 g/10 min, or 1.0 g/10 min, or 1.5 g/10 min to 2 g/10 min. or 5 g/10 min. or 10 g/10 min, or 15 g/10 min, or 20 g/10 min, or 30 g/10 min, or 40 g/10 min, or 50 g/10 min. In another embodiment, the functionalized ethylene-based polymer has a melt index (MI) from 0.1 g/10 min to 50 g/10 min, or from 0.5 g/10 min to 10 g/10 min, or from 0.5 g/10 min to 5 g/10 min.

In an embodiment, the silane functionalized ethylene-based polymer is an ethylene/silane copolymer. The ethylene/silane copolymer contains ethylene and the hydrolyzable silane monomer as the only monomeric units. In another embodiment, the ethylene/silane copolymer optionally includes a C₃, or C₄ to C₆, or C₈, or C₁₀, or C₁₂, or C₁₆, or C₁₈, or C₂₀ α-olefin; an unsaturated ester, and combinations thereof. In an embodiment, the ethylene/silane copolymer is an ethylene/unsaturated ester/silane reactor copolymer. Nonlimiting examples of suitable ethylene/silane copolymers include SI-LINK™ DFDA-5451 NT and SI-LINK™ AC DFDB-5451 NT, each available from The Dow Chemical Company.

The ethylene/silane reactor copolymer may comprise two or more embodiments disclosed herein.

In an embodiment, the silane functionalized ethylene-based polymer is a Si-g-PE.

The base ethylene-based polymer for the Si-g-PE includes from 50 wt %, or 55 w %, or 60 wt %, or 65 wt %, or 70 wt %, or 80 wt %, or 90 wt %, or 95 wt % to 97 wt %, or 98 wt %, or 99 wt %, or 100 wt % ethylene, based on the total weight of the base ethylene-based polymer.

In an embodiment, the base ethylene-based polymer for the Si-g-PE is an ethylene/α-olefin copolymer. The α-olefin contains from 3, or 4 to 6, or 8, or 12, or 20 carbon atoms. Nonlimiting examples of suitable α-olefin include propylene, butene, hexene, and octene. In an embodiment, the ethylene-based copolymer is an ethylene/octene copolymer. When the ethylene-based copolymer is an ethylene/α-olefin copolymer, the Si-g-PE is a silane-grafted ethylene/α-olefin copolymer. Nonlimiting examples of suitable ethylene/α-olefin copolymers useful as the base ethylene-based polymer for the Si-g-PE include the ENGAGE™ and INFUSE™ resins available from the Dow Chemical Company.

Blends of silane functionalized ethylene-based polymers may also be used, and the silane-functionalized ethylene-based polymer(s) may be diluted with one or more other polyolefins to the extent that the polyolefins are (i) miscible or compatible with one another, and (ii) the silane functionalized ethylene-based polymer(s) constitutes from 30 wt %, or 40 wt %, or 50 wt %, or 55 wt %, or 60 wt %, or 70 wt %, or 80 wt %, or 90 wt %, or 95 wt %, or 99 wt % to less than 100 wt % of the blend (based on the combined weight of the polyolefins, including the silane functionalized ethylene-based polymer).

The silane functionalized ethylene-based polymer may comprise two or more embodiments disclosed herein.

B. Hindered Phenol Antioxidant

The composition contains a hindered phenol antioxidant.

A “hindered phenol antioxidant” is a primary antioxidant that acts as a radical scavenger. The hindered phenol antioxidant contains a phenol group. Nonlimiting examples of suitable hindered phenol antioxidants include pentaerythritol tetrakis(3-(3,5-di-tert-butyl-4-hydroxyphenyl)propionate); 1,3,5-trimethyl-2,4,6-tris-(3,5-di-tert-butyl-4-hydroxybenzyl)-benzene; pentaerythrityl tetrakis-3(3,5-di-tert-butyl-4-hydroxyphenyl)-propionate; n-octadecyl-3(3,5-di-tert-butyl-4-hydroxyphenyl)-propionate; 4,4′-methylenebis(2,6-tert-butyl-phenol); 4,4′-thiobis(6-tert-butyl-o-cresol); 2,6-di-tertbutylphenol; 6-(4-hydroxyphenoxy)-2,4-bis(n-octyl-thio)-1,3,5 triazine; di-n-octylthio)ethyl 3,5-di-tert-butyl-4-hydroxy-benzoate; and sorbitol hexa[3-(3,5-di-tert-butyl-4-hydroxy-phenyl)-propionate]; and combinations thereof. Such hindered phenol antioxidants are commercially available from BASF and include IRGANOX™ 565, 1010, 1076 and 1726.

In an embodiment, the hindered phenol antioxidant is pentaerythritol tetrakis(3-(3,5-di-tert-butyl-4-hydroxyphenyl)propionate), commercially available as IRGANOX™ 1010 from BASF.

The hindered phenol antioxidant may comprise two or more embodiments disclosed herein.

C. Aromatic Amine-Aromatic Sulfonic Acid Salt

The composition contains an aromatic amine-aromatic sulfonic acid salt.

An “aromatic amine-aromatic sulfonic acid salt,” or “AS-ASAS,” is a salt compound formed from an aromatic amine and an aromatic sulfonic acid. The AS-ASAS may be a mono-amine, a di-amine, or a tri-amine. The AS-ASAS excludes salt compounds formed from linear amines and/or branched amines. Further, the AS-ASAS excludes salt compounds formed from linear sulfonic acids and/or branched sulfonic acids.

An “aromatic amine” is a compound having the following Structure (II):

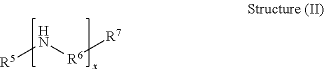

wherein R⁵ is selected from an aryl group, a substituted aryl group, an alkyl group, or a substituted alkyl group; R⁶ is selected from an aryl group, and a substituted aryl group; R⁷ is selected from an aryl group, a substituted aryl group, an alkyl group, a substituted alkyl group, or hydrogen; and X is an integer from 1 to 2, or 3, or 4.

In an embodiment, in Structure (II), R⁵ is selected from a C₆-C₄₀ aryl group, a substituted C₆-C₄₀ aryl group, a C₁-C₄₀ alkyl group, or a substituted C₁-C₄₀ alkyl group; R⁶ is selected from a C₆-C₄₀ aryl group, and a substituted C₆-C₄₀ aryl group; R⁷ is selected from a C₆-C₄₀ aryl group, a substituted C₆-C₄₀ aryl group, a C₁-C₄₀ alkyl group, a substituted C₁-C₄₀ alkyl group, or hydrogen; and X is an integer from 1 to 2, or 3, or 4.

Nonlimiting examples of suitable aromatic amines include 4,4′-bis (alpha, alpha-dimethylbenzyl) diphenylamine; N1-(4-methylpentan-2-yl)-N4-phenylbenzene-1,4-diamine, N,N-diphenyl-p-phenylenediamine; di([1,1′-biphenyl]-4-yl)amine; (2,2,4-trimethyl-1,2-dihydroquinoline); 9,9-Dimethyl-9,10-dihydroacridine; N-Phenyl-2-naphthylamine; N1,N4-di(naphthalen-2-yl)benzene-1,4-diamine; N,N′-Bis-(1,4-Dimethylpentyl)-P-Phenylenediamine; N,N′-di-sec-butyl-1,4-phenylenediamine; N-Isopropyl-N′-phenyl-1,4-phenylenediamine; 6-Ethoxy-2,2,4-trimethyl-1,2-dihydroquinoline, and combinations thereof.

An “aromatic sulfonic acid” is a compound having the following Structure (III):

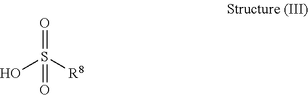

wherein R⁸ is selected from an aryl group and a substituted aryl group.

Nonlimiting examples of suitable aromatic sulfonic acids include naphthalene sulfonic acid; dodecylbenzenesulfonic acid (DBSA); 4-methylbenzenesulfonic acid; naphthalene-2-sulfonic acid; 4-dodecylbenzene sulfonic acid; P-toluenesulfonic acid; 2,4,6-trimethylbenzenesulfonic acid; 2,4,6-trichlorobenzenesulfonic acid; naphthalene-2-sulfonic acid; naphthalene-1-sulfonic acid; 4-methylbenzenesulfonic acid; benzene sulfonic acid, substituted naphthalene-1-sulfonic acid, substituted naphthalene-2-sulfonic acid; 4-(tert-butyl)benzenesulfonic acid, and combinations thereof.

The AS-ASAS has the following Structure (I):

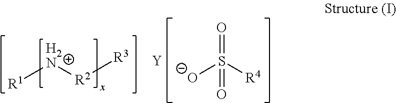

wherein Y is an integer from 1 to 2, or 3; R¹ is selected from an aryl group, a substituted aryl group, an alkyl group, or a substituted alkyl group; R² is selected from an aryl group, and a substituted aryl group; R³ is selected from an aryl group, a substituted aryl group, an alkyl group, a substituted alkyl group, or hydrogen; R⁴ is selected from an aryl group, and a substituted aryl group; and X is an integer from 1 to 2, or 3, or 4.

In an embodiment, in Structure (I): Y is from 1 to 2; X is from 1 to 2, or from 1 to 3, or from 1 to 4; R¹ is selected from a C₆-C₄₀, or C₆-C₂₀, or C₆-C₁₅, or C₆ aryl group; a substituted C₆-C₄₀, or C₆-C₂₀, or C₆-C₁₅, or C₆ aryl group; a C₁-C₄₀, or C₁-C₂₀, or C₁-C₁₀, or C₄-C₈ alkyl group; or a substituted C₁-C₂₀, or C₁-C₁₀, or C₄-C₈ alkyl group; R² is selected from a C₆-C₄₀, or C₆-C₂₀, or C₆-C₁₅, or C₆ aryl group; and a substituted C₆-C₄₀, or C₆-C₂₀, or C₆-C₁₅, or C₆ aryl group; R³ is selected from a C₆-C₄₀, or C₆-C₂₀, or C₆-C₁₅, or C₆ aryl group; a substituted C₆-C₄₀, or C₆-C₁₅, or C₆C aryl group; a C₁-C₄₀, or C₁-C₂₀, or C₁-C₁₀, or C₄-C₈ alkyl group; a substituted C₁-C₄₀, or C₁-C₂₀, or C₁-C₁₀, or C₄-C₈ alkyl group; or hydrogen, and R⁴ is selected from a C₆-C₄₀, or C₆-C₂₀, or C₆-C₁₅, or C₆ aryl group; and a substituted C₆-C₄₀, or C₆-C₂₀, or C₆-C₁₅, or C₆ aryl group.

In an embodiment, the AS-ASAS has a molar ratio of sulfur to nitrogen from 0.8:1, or 1:1 to 1.3:1. In another embodiment, the AS-ASAS has a molar ratio of sulfur to nitrogen of 1:1.

Nonlimiting examples of suitable AS-ASAS are depicted below in Table C, and include the Structures (IV)-(XI), and combinations thereof.

TABLE C
AS-ASAS Structures

| | |
|---|---|
| 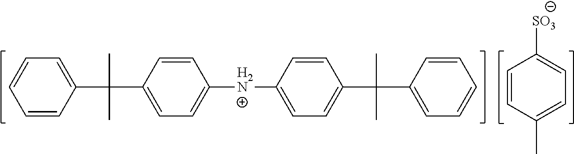 | Structure (IV) |
| 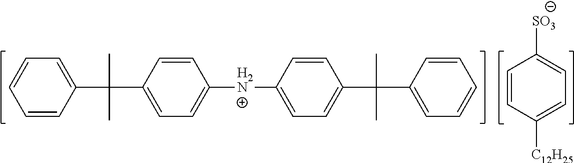 | Structure (V) |
| 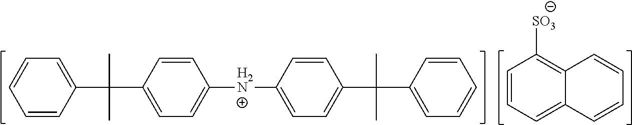 | Structure (VI) |
| 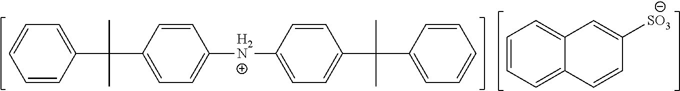 | Structure (VII) |
| 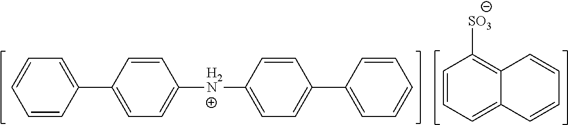 | Structure (VIII) |
| 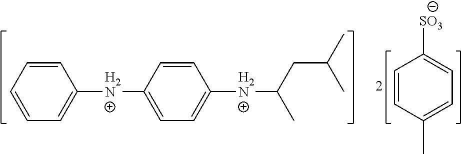 | Structure (IX) |
| 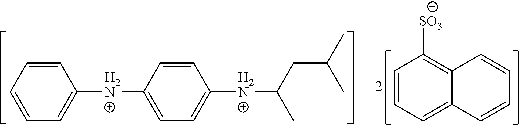 | Structure (X) |
| 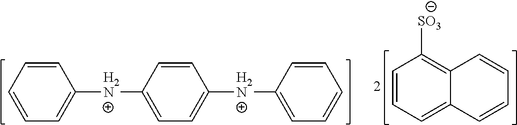 | Structure (XI) |

In an embodiment, the AS-ASAS is selected from Structure (IV), Structure (V), Structure (VI), Structure (VII), Structure (VIII), and Structure (XI).

In an embodiment, the AS-ASAS is selected from Structure (IV), Structure (V), Structure (VI), and Structure (VII).

In an embodiment, the AS-ASAS is selected from Structure (IX) and Structure (X).

In an embodiment, the AS-ASAS is selected from Structure (IV) and Structure (IX).

In an embodiment, the AS-ASAS is selected from Structure (VI), Structure (VIII), Structure (X), and Structure (XI).

The AS-ASAS is not polymeric. In other words, the AS-ASAS is void of, or substantially void of, dimers, trimers, and tetramers of the aromatic amine.

In an embodiment, the AS-ASAS is synthesized by mixing the aromatic amine with the aromatic sulfonic acid in an organic solvent or a wax, for a period of from one, or two to three, or four, or five, or six hours at room temperature (23-25° C.). Nonlimiting examples of suitable organic solvent include dichloromethane, toluene, and combinations thereof.

The aromatic amine-aromatic sulfonic acid salt (AA-ASAS) may comprise two or more embodiments disclosed herein.

D. Optional Additive

In an embodiment, the composition includes (A) the silane functionalized ethylene-based polymer, (B) the hindered phenol antioxidant, (C) the aromatic amine-aromatic sulfonic acid salt, and (D) one or more optional additives.

Nonlimiting examples of suitable optional additives include antioxidants (other than the (B) hindered phenol antioxidant), colorants, corrosion inhibitors, lubricants, wax, silanol condensation catalysts, ultra violet (UV) absorbers or stabilizers, anti-blocking agents, coupling agents, compatibilizers, plasticizers, fillers, processing aids, moisture scavengers, scorch retardants, metal deactivators, siloxanes, crosslinking coagents, extends oils, and polyolefins (other than the (A) silane functionalized ethylene-based polymer), and combinations thereof.

In an embodiment, the composition includes an antioxidant that is different than the (B) hindered phenol antioxidant. A nonlimiting example of a suitable antioxidant is a phosphite antioxidant, such as IRGAFOS™ 168, available from BASF. In an embodiment, the composition contains from 0 wt %, or 0.01 wt % to 0.5 wt %, or 1.0 wt %, or 2.0 wt %, or 3.0 wt % antioxidant, based on total weight of the composition.

In an embodiment, the composition includes a wax. The wax may be used to reduce the melt viscosity of the composition. Nonlimiting examples of suitable wax include ethylene-based polymer wax, propylene-based polymer wax, paraffin wax, microcrystalline wax, by-product polyethylene wax, Fischer-Tropsch wax, oxidized Fischer-Tropsch wax, functionalized wax such as hydroxy stearamide wax and fatty amide wax, and combinations thereof.

In an embodiment, the composition includes silanol condensation catalyst, such as Lewis and Brønsted acids and bases. A “silanol condensation catalyst” promotes crosslinking of the silanol functionalized polyolefin. Lewis acids are chemical species that can accept an electron pair from a Lewis base. Lewis bases are chemical species that can donate an electron pair to a Lewis acid. Nonlimiting examples of suitable Lewis acids include the tin carboxylates such as dibutyl tin dilaurate (DBTDL), and various other organo-metal compounds such as lead naphthenate, zinc caprylate and cobalt naphthenate. Nonlimiting examples of suitable Lewis bases include the primary, secondary and tertiary amines. These catalysts are typically used in moisture cure applications. In an embodiment, the composition includes from 0 wt %, or 0.001 wt % to 0.1 wt %, or 1.0 wt % silanol condensation catalyst, based on the total weight of the composition. During the MONOSIL™ process, the silanol condensation catalyst is typically added to the reaction-extruder so that it is present during the grafting reaction of silane to the polyolefin backbone to form the in situ Si-g-PE. As such, the silane functionalized ethylene-based polymer may experience some coupling (light crosslinking) before it leaves the extruder with the completion of the crosslinking after it has left the extruder, typically upon exposure to moisture (e.g., a sauna bath or a cooling bath) and/or the humidity present in the environment in which it is stored, transported or used.

In an embodiment, the composition includes an ultra violet (UV) absorber or stabilizer. A nonlimiting example of a suitable UV stabilizer is a hindered amine light stabilizer (HALS), such as 1,3,5-Triazine-2,4,6-triamine, N,N-1,2-ethanediylbisN-3-4,6-bisbutyl(1,2,2,6,6-pentamethyl-4-piperidinyl)amino-1,3,5-triazin-2-ylaminopropyl-N,N-dibutyl-N,N-bis(1,2,2,6,6-pentamethyl-4-piperidinyl)-1,5,8,12-tetrakis[4,6-bis(n-butyl-n-1,2,2,6,6-pentamethyl-4-piperidylamino)-1,3,5-triazin-2-yl]-1,5,8,12-tetraazadodecane, which is commercially available as SABO™ STAB UV-119 from SABO S.p.A. of Levate, Italy. In an embodiment, the composition contains from 0 wt %, or 0.001% to 0.01 wt %, or 1.0 wt %, or 3.0 wt % UV absorber or stabilizer, based on total weight of the composition.

In an embodiment, the composition includes a metal deactivator. Metal deactivators suppress the catalytic action of metal surfaces and traces of metallic minerals. Metal deactivators convert the traces of metal and metal surfaces into an inactive form, e.g., by sequestering. Nonlimiting examples of suitable metal deactivators include 1,2-bis(3,5-di-tert-butyl-4-hydroxyhydrocinnamoyl)hydrazine, 2,2′-oxamindo bis[ethyl 3-(3,5-di-tert-butyl-4-hydroxyphenyl)propionate], and oxalyl bis(benzylidenehydrazide) (OABH). In an embodiment, the composition contains from 0 wt %, or greater than 0 wt %, or 0.01 wt % to 0.05 wt %, or 1 wt %, or 10 wt % metal deactivator, based on the total weight of the composition.

In an embodiment, the composition includes a filler. Nonlimiting examples of suitable fillers include zinc oxide, zinc borate, zinc molybdate, zinc sulfide, carbon black, organo-clay, and combinations thereof. The filler may or may not have flame retardant properties. In an embodiment, the filler is coated with amaterial (such as stearic acid) that will prevent or retard any tendency that the filler might otherwise have to interfere with the silane cure reaction. In an embodiment, the composition contains from 0 wt %, or 0.01 wt % to 1.0 wt %, or 3.0 wt %, or 5.0 wt % filler, based on total weight of the composition.

In an embodiment, the composition includes a processing aid. Nonlimiting examples of suitable processing aids include oils, organic acids (such as stearic acid), and metal salts of organic acids (such as zinc stearate). In an embodiment, the composition contains from 0 wt %, or 0.01 wt % to 1.0 wt %, or 3.0 wt % processing aid, based on total weight of the composition.

In an embodiment, the composition includes a moisture scavenger. Moisture scavengers remove or deactivate unwanted water in the composition to prevent unwanted (premature) crosslinking and other water-initiated reactions in the composition during storage or at extrusion conditions. Nonlimiting examples of moisture scavengers include organic compounds selected from ortho esters, acetals, ketals or silanes such as alkoxy silanes. In an embodiment, the moisture scavenger is an alkoxy silane (e.g., hexadecyltrimethoxysilane). The alkoxy silane moisture scavenger is not grafted to or copolymerized with a polyolefin. The moisture scavenger is present in an amount from 0 wt %, or greater than 0 wt %, or 0.01 wt % to 0.2 wt %, or 1.0 wt %, based on the total weight of the composition.

In an embodiment, the composition includes a siloxane. A nonlimiting example of a suitable siloxane is a polydimethylsiloxane (PDMS), such as dimethylvinylsilyl terminated polydimethylsiloxane. In an embodiment, the composition contains from 0.2 wt %, or 0.5 wt % to 1.0 wt %, or 5.0 wt % siloxane, based on the total weight of the composition.

In an embodiment, the composition includes a crosslinking coagent. A “crosslinking coagent” is a substance that improves the crosslinking efficiency of a composition. A nonlimiting example of a suitable crosslinking coagent is triallyl isocyanurate (TAIC). In an embodiment, the composition contains from 0 wt %, or greater than 0 wt %, or 0.1 wt % to 0.5 wt %, or 1.0 wt % crosslinking coagent, based on the total weight of the composition.

In an embodiment, the composition includes a polyolefin that is different than the (A) silane functionalized ethylene-based polymer. Nonlimiting examples of suitable polyolefins include ethylene-based polymer, propylene-based polymer, and combinations thereof. Nonlimiting examples of suitable ethylene-based polymer include LDPE, ethylene/ethyl acrylate (EEA) copolymer, and combinations thereof. In an embodiment, the polyolefin is not functionalized. In an embodiment, the composition contains from 0 wt %, or 1 wt %, or 3 wt % to 5 wt %, or 10 wt %, or 15 wt %, or 20 wt %, or 50 wt %, or 70 wt % polyolefin, based on the total weight of the composition. In another embodiment, the composition contains from 1 wt % to 70 wt %, or from 1 wt % to 10 wt %, or from 1 wt % to 5 wt % polyolefin (such as LDPE and/or EEA copolymer), based on the total weight of the composition. In an embodiment, the polyolefin is a carrier polyolefin that is combined with the (B) hindered phenol antioxidant and/or the (C) AS-ASAS to form a catalyst masterbatch, and then the catalyst masterbatch is combined with the (A) silane-functionalized ethylene-based polymer to form the composition.

In an embodiment, the composition contains from 0 wt %, or greater than 0 wt %, or 0.001 wt % to 0.01 wt %, or 0.1 wt %, or 0.5 wt %, or 1.0 wt %, or 2.0 wt %, or 5.0 wt %, or 10.0 wt %, or 15.0 wt %, or 20.0 wt % additive, based on the total weight of the composition.

The additive may comprise two or more embodiments disclosed herein.

E. Composition

The composition contains (A) the silane functionalized ethylene-based polymer, (B) the hindered phenol antioxidant, (C) the aromatic amine-aromatic sulfonic acid salt (AS-ASAS), and, optionally, (D) an additive. In an embodiment, the AS-ASAS has the Structure (I).

In an embodiment, the composition is a crosslinkable composition. In a further embodiment, the composition is a moisture curable composition. In other words, the composition is capable of crosslinking upon exposure to moisture (e.g., a sauna bath or a cooling bath) and/or the humidity present in the environment in which it is stored, transported or used. Moisture cure conditions include the presence of water (e.g., as a bath or humidity present in the environment), and a temperature of from 20° C., or 23° C. to 25° C. to 30° C.

In an embodiment, the composition is a crosslinked composition. The crosslinked composition is formed by crosslinking the crosslinkable composition. In an embodiment, the crosslinking of the crosslinkable composition begins in an extruder. In another embodiment, crosslinking is delayed until the crosslinkable composition is extruded, such as upon a conductor. Crosslinking of the crosslinkable composition is initiated and/or accelerated through exposure to humid environment (e.g., ambient conditions or cure in a sauna or water bath). In an embodiment, crosslinking of the crosslinkable composition is initiated and/or accelerated through exposure to moisture. The crosslinked composition includes bonds between the silane functionalized ethylene-based polymer chains.

In an embodiment, the composition contains, consists essentially of, or consists of: (A) the silane functionalized ethylene-based polymer, (B) the hindered phenol antioxidant, (C) the AS-ASAS, and, optionally, (D) an additive.

In an embodiment, the composition contains from 30 wt %, or 40 wt %, or 50 wt %, or 60 wt %, or 70 wt %, or 80 wt %, or 90 wt % to 95 wt %, or 97 wt %, or 98 wt %, or 99 wt % silane functionalized ethylene-based polymer, based on the total weight of the composition.

In an embodiment, the composition contains from 0.03 wt %, or 0.05 wt %, or 0.09 wt % to 0.10 wt % or 0.2 wt %, or 0.5 wt % or 1.0 wt % hindered phenol antioxidant, based on the total weight of the composition.

In an embodiment, the composition contains from 0.05 wt %, or 0.08 wt %, or 0.10 wt %, or 0.11 wt % to 0.16 wt %, or 0.20 wt %, or 0.50 wt %, or 1.0 wt %, or 2.0 wt %, or 3.0 wt %, or 4.0 wt %, or 5.0 wt % AS-ASAS, based on the total weight of the composition.

In an embodiment, the composition contains, consists essentially of, or consists of: (A) from 30 wt % to 99 wt %, or from 50 wt % to 99 wt %, or from 80 wt % to 99 wt %, or from 90 wt % to 99 wt %, or from 90 wt % to 95 wt % functionalized ethylene-based polymer (such as ethylene/silane copolymer); (B) from 0.03 wt % to 1.0 wt %, or from 0.03 wt % to 0.5 wt %, or from 0.05 wt % to 0.2 wt %, or from 0.09 wt % to 0.10 wt % hindered phenol antioxidant; (C) from 0.05 wt % to 5.0 wt %, or from 0.05 wt % to 1.0 wt %, or from 0.05 wt % to 0.50 wt %, or from 0.10 wt % to 0.20 wt %, or from 0.11 wt % to 0.16 wt % AS-ASAS (such as the AS-ASAS having the Structure (I)); and (D) from 0 wt % to 20 wt %, or from greater than 0 wt % to 20 wt %, or from greater than 0 wt % to 10 wt % additive, based on the total weight of the composition. In a further embodiment, the composition is a crosslinkable composition.

In an embodiment, the composition has a hot creep after curing in a water bath at 90° C. for 1 hour of less than 160%, or less than 130%, or less than 110%, or less than 100%, or less than 50%; or from 0%, or 40% to 50%, or 100%, or 110%, or 120%, or 160%. In an embodiment, the composition has a hot creep after curing in a water bath at 90° C. for 3 hours of less than 150%, or less than 130%, or less than 110%, or less than 100%, or less than 80%, or less than 70%, or less than 40%; or from 0%, or 20%, or 30% to 40%, or 70%, or 80%, or 100%, or 110%, or 130%, or 150%. In an embodiment, the composition has a hot creep after curing in a water bath at 90° C. for 6 hours of less than 150%, or less than 100%, or less than 80%; or from 0%, or 20%, or 50%, or 70% to 75%, or 80%, or 100%, or 150%.

In an embodiment, the composition has a hot creep after curing in ambient environment for 69 hours of less than 100%, or less than 70%; or from 0%, or 20%, or 50% to 70%, or 100%. In an embodiment, the composition has a hot creep after curing in ambient environment for 90 hours of less than 110%, or less than 100%, or less than 80%; or from 0%, or 20%, or 50% to 70%, or 105%, or 110%. In an embodiment, the composition has a hot creep after curing in ambient environment for 100 hours of less than 140%; or from 0%, or 20%, or 50%, or 70% to 130%, or 150%. In an embodiment, the composition has a hot creep after curing in ambient environment for 168 hours of less than 140%, or less than 100%, or less than 90%, or less than 60%; or from 0%, or 20%, or 50% to 60%, or 95%, or 100%, or 130%, or 140%. In an embodiment, the composition has a hot creep after curing in ambient environment for 230 hours of less than 100%, or less than 80%, or less than 60%, or less than 55%; or from 0%, or 20% to 55%, or 60%, or 80%, or 100%.

In an embodiment, the composition has a hot creep after curing in a water bath at 90° C., (i) for 1 hour of less than 160%, or less than 130%, or less than 110%, or less than 100%, or less than 50%; and/or (ii) for 3 hours of less than 150%, or less than 130%, or less than 110%, or less than 100%, or less than 80%, or less than 70%, or less than 40%; and/or (iii) for 6 hours of less than 150%, or less than 100%, or less than 80%. In an embodiment, the composition has a hot creep after curing in ambient environment, (i) for 69 hours of less than 100%, or less than 70%; and/or (ii) for 90 hours of less than 110%, or less than 100%, or less than 80%; and/or (iii) for 100 hours of less than 140%; and/or (iv) for 168 hours of less than 140%, or less than 100%, or less than 90%, or less than 60%; and/or (v) for 230 hours of less than 100%, or less than 80%, or less than 60%, or less than 55%. A low hot creep is advantageous in wire and cable applications because it demonstrates that the composition has crosslinked (i.e., cured).

In an embodiment, the AS-ASAS, the hindered phenol antioxidant, and a carrier polyolefin are combined to form a masterbatch. Then, the masterbatch is combined with the silane-functionalized ethylene-based polymer to form the composition. In an embodiment, the masterbatch (also referred to as a “catalyst masterbatch”) contains, consists essentially of, or consists of: (i) from 0.05 wt %, or 0.10 wt %, or 0.50 wt %, or 1.0 wt %, or 2.0 wt %, or 2.3 wt % to 3.2 wt %, or 4.0 wt %, or 5.0 wt %, or 10 wt % AS-ASAS; (ii) from 0.03 wt %, or 0.05 wt %, or 0.10 wt %, or 0.50 wt %, or 1.0 wt %, or 1.50 wt %, or 1.90 wt % to 2.0 wt %, or 3.0 wt %, or 4.0 wt % hindered phenol antioxidant; and (iii) from 86 wt %, or 90 wt %, or 94 wt % to 96 wt %, or 99 wt %, or 99.92 wt % carrier polyolefin (such as EEA copolymer and/or LDPE), based on the total weight of the masterbatch. In a further embodiment, the carrier polyolefin is a blend of EEA copolymer and LDPE at a weight ratio of 1:1, based on the total weight of the blend.

In an embodiment, the composition, or the masterbatch, exhibits an isobutylene reduction of at least 50% compared to the same composition, or masterbatch containing the aromatic sulfonic acid of the aromatic amine-aromatic sulfonic acid salt, instead of the salt. In an embodiment, the composition, or the masterbatch, exhibits an isobutylene reduction as measured by HSGC with Sample Preparation Method 1 of at least 50% compared to the same composition, or masterbatch containing the aromatic sulfonic acid of the aromatic amine-aromatic sulfonic acid salt, instead of the salt. In another embodiment, the composition, or the masterbatch, exhibits an isobutylene reduction as measured by HSGC with Sample Preparation Method 2 of at least 50% compared to the same composition, or masterbatch containing the aromatic sulfonic acid of the aromatic amine-aromatic sulfonic acid salt, instead of the salt.

In an embodiment, the composition, or the masterbatch, exhibits an isobutylene generation peak area of less than 6,000,000 per gram (g⁻¹), or less than 5,000,000 g⁻¹, or less than 4,000,000 g⁻¹; or from 0 g⁻¹ to 6,000,000 g⁻¹, or from 1,000 g⁻¹ to 6,000,000 g⁻¹, or from 500,000 g⁻¹ to 6,000,000 g⁻¹, or from 500,000 g⁻¹ to 5,000,000 g⁻¹, as measured by HSGC with Sample Preparation Method 1.

In an embodiment, the composition, or the masterbatch, exhibits an isobutylene generation peak area of less than 1.4×10¹¹ per mole of sulfur (mol⁻¹), or less than 1.2×10¹¹ mol⁻¹, or less than 1.0×10¹¹ mol⁻¹, or less than 5.0×10¹⁰ mol⁻¹; or from 0 mol⁻¹ to 1.4×10¹¹ mol⁻¹, or from 1.0×10⁷ mol⁻¹ to 1.4×10¹¹ mol⁻¹, or from 1.0×10¹⁰ mol⁻¹ to 1.4×10¹¹ mol⁻¹, as measured by HSGC with Sample Preparation Method 1.

In an embodiment, the composition, or the masterbatch, exhibits an isobutylene generation peak area of less than 1,000,000 per gram (g⁻¹), or less than 100,000 g⁻¹, or less than 80,000 g⁻¹, or less than 75,000 g⁻¹; or from 0 g⁻¹ to 1,000, g⁻¹, or from 100 g⁻¹ to 100,000 g⁻¹, or from 100 g⁻¹ to 80,000 g⁻¹, or from 100 g⁻¹ to 75,000 g⁻¹, as measured by HSGC with Sample Preparation Method 2.

In an embodiment, the composition, or the masterbatch, exhibits an isobutylene generation peak area of less than 1.8×10⁹ per mole of sulfur (mol⁻¹), or less than 1.7×10⁹ mol⁻¹, or less than 1.6×10⁹ mol⁻¹, or less than 1.5×10⁹ mol⁻¹ or from 0 mol⁻¹ to 1.8×10⁹ mol⁻¹, or from 1.0×10⁶ mol⁻¹ to 1.80×10⁹ mol⁻¹, or from 1.0×10⁶ mol⁻¹ to 1.70×10⁹ mol⁻¹, as measured by HSGC with Sample Preparation Method 2.

Low isobutylene generation (e.g., a peak area of less than 6,000,000 g⁻¹ and/or a peak area of less than 1.4×10¹¹ mol⁻¹, as measured by HSGC with Sample Preparation Method 1) is advantageous because isobutylene is toxic. Therefore, a reduction in isobutylene generation leads to improved safety in handling the composition and masterbatch, as well as decreased production costs. Furthermore, isobutylene is generated in the present composition and masterbatch as a result of decomposition of the hindered phenolic antioxidant. Therefore, reduced isobutylene generation indicates that decomposition of the hindered phenolic antioxidant is advantageously reduced, or avoided.

In an embodiment, the composition contains, consists essentially of, or consists of:

(i) from 1 wt % to 5 wt %, or 10 wt %, or 20 wt %, or 40 wt %, or 50 wt % catalyst masterbatch, based on the total weight of the composition, and the catalyst masterbatch containing, consisting essentially of, or consisting of: (a) from 0.05 wt %, or 0.10 wt %, or 0.50 wt %, or 1.01 wt %, or 2.01 wt %, or 2.3 wt % to 3.2 wt %, or 4.0 wt %, or 5.0 wt %, or 10 wt % AS-ASAS (such as an AS-ASAS having the Structure (I) and a molar ratio of sulfur to nitrogen of 1:1); (b) from 0.03 wt %, or 0.05 wt %, or 0.10 wt %, or 0.50 wt %, or 1.0 wt %, or 1.50 wt %, or 1.90 wt % to 2.0 wt %, or 3.0 wt %, or 4.0 wt % hindered phenol antioxidant; and (c) from 86 wt %, or 90 wt %, or 94 wt % to 96 wt %, or 99 wt %, or 99.92 wt % carrier polyolefin (such as EEA copolymer and/or LDPE), based on the total weight of the masterbatch;

(ii) from 50 wt %, or 60 wt %, or 80 wt %, or 90 wt %, or 95 wt % to 99 wt % silane-functionalized ethylene-based polymer (e.g., ethylene/silane copolymer);

the catalyst masterbatch has one, some, or all of the following properties: (a) an isobutylene reduction as measured by HSGC with Sample Preparation Method 1 of at least 50% compared to the same masterbatch containing the aromatic sulfonic acid of the aromatic amine-aromatic sulfonic acid salt, instead of the salt; and/or (b) an isobutylene reduction as measured by HSGC with Sample Preparation Method 2 of at least 50% compared to the same masterbatch containing the aromatic sulfonic acid of the aromatic amine-aromatic sulfonic acid salt, instead of the salt; and/or (c) an isobutylene generation peak area from 0 g⁻¹ to 6,000,000 g⁻¹, or from 1,000 g⁻¹ to 6,000,000 g⁻¹, or from 500,000 g⁻¹ to 6,000,000 g⁻¹, or from 500,000 g⁻¹ to 5,000,000 g⁻¹, as measured by HSGC with Sample Preparation Method 1; and/or (d) an isobutylene generation peak area of from 0 mol⁻¹ to 1.4×10¹¹ mol⁻¹, or from 1.0×10⁷ mol⁻¹ to 1.4×10¹¹ mol⁻¹, or from 1.0×10¹⁰ mol⁻¹ to 1.4×10¹¹ mol⁻¹, as measured by HSGC with Sample Preparation Method 1; and/or (e) an isobutylene generation peak area from 0 g⁻¹ to 1,000,000 g⁻¹, or from 100 g⁻¹ to 100,000 g⁻¹, or from 100 g⁻¹ to 80,000 g⁻¹, or from 100 g⁻¹ to 75,000 g⁻¹, as measured by HSGC with Sample Preparation Method 2; and/or (f) an isobutylene generation peak area of from 0 mol⁻¹ to 1.8×10⁹ mol⁻¹, or from 1.0×10⁶ mol⁻¹ to 1.80×10⁹ mol⁻¹, or from 1.0×10⁶ mol⁻¹ to 1.70×10⁹ mol⁻¹, as measured by HSGC with Sample Preparation Method 2; and

the composition has one, some, or all of the following properties: (A) a hot creep after curing in a water bath at 90° C., (A1) for 1 hour of less than 160% or less than 130%, or less than 110%, or less than 100%, or less than 50%; and/or (A2) for 3 hours of less than 150%, or less than 130%, or less than 110%, or less than 100% or less than 80%, or less than 70%, or less than 40%; and/or (A3) for 6 hours of less than 150%, or less than 100%, or less than 80%, and/or (B) a hot creep after curing in ambient environment, (B1) for 69 hours of less than 100%, or less than 70%; and/or (B2) for 90 hours of less than 110%, or less than 100%, or less than 80%; and/or (B3) for 100 hours of less than 140%; and/or (B4) for 168 hours of less than 140%, or less than 100%, or less than 90%, or less than 60%; and/or (B5) for 230 hours of less than 100%, or less than 80%, or less than 60%, or less than 55%.

It is understood that the sum of the components in each of the foregoing compositions yields 100 weight percent (wt %).

In an embodiment, the composition is void of or substantially void of, propylene-based polymer, such as silane functionalized propylene-based polymer and maleic acid functionalized propylene-based polymer.

In an embodiment, the composition is void of, or substantially void of, sulfonate esters and/or esters of sulfonic acid.

In an embodiment, the composition is void of, or substantially void of, epoxy resin.

The composition may comprise two or more embodiments disclosed herein.

F. Coated Conductor

The present disclosure provides a coated conductor. The coated conductor includes a conductor and a coating on the conductor, the coating including a composition containing (A) silane functionalized ethylene-based polymer, (B) hindered phenol antioxidant. (C) AS-ASAS, and, optionally, (D) an additive.

The composition may be any composition disclosed herein.

In an embodiment, the composition is a crosslinked composition.

In an embodiment, the coating is an insulation sheath for a conductor. In another embodiment, the coating is a jacket for a conductor.

The process for producing a coated conductor includes heating the composition to at least the melting temperature of the silane functionalized ethylene-based polymer, and then extruding the polymeric melt blend onto the conductor. The term “onto” includes direct contact or indirect contact between the polymeric melt blend and the conductor. The polymeric melt blend is in an extrudable state. During and/or after extrusion, crosslinking occurs to form a crosslinked composition.

The coating is located on the conductor. The coating may be one or more inner layers such as an insulating layer. The coating may wholly or partially cover or otherwise surround or encase the conductor. The coating may be the sole component surrounding the conductor. When the coating is the sole component surrounding the conductor, the coating may serve as a jacket and/or an insulation. In an embodiment, the coating is the outermost layer on the coated conductor. Alternatively, the coating may be one layer of a multilayer jacket or sheath encasing the metal conductor. In an embodiment, the coating directly contacts the conductor. In another embodiment, the coating directly contacts an insulation layer surrounding the conductor.

In an embodiment, the coating directly contacts the conductor. The term “directly contacts,” as used herein, is a coating configuration whereby the coating is located immediately adjacent to the conductor, the coating touches the conductor, and no intervening layers, no intervening coatings, and/or no intervening structures, are present between the coating and the conductor.

In another embodiment, the coating indirectly contacts the conductor. The term “indirectly contacts,” as used herein, is a coating configuration whereby an intervening layer, an intervening coating, or an intervening structure, is present between the coating and the conductor. Nonlimiting examples of suitable intervening layers, intervening coatings, and intervening structures include insulation layers, moisture barrier layers, buffer tubes, and combinations thereof. Nonlimiting examples of suitable insulation layers include foamed insulation layers, thermoplastic insulation layers, crosslinked insulation layers, and combinations thereof.

In an embodiment, the composition contains carbon black, and the coating is a semiconductive layer on a conductor.

The coating is crosslinked. In an embodiment, crosslinking of the crosslinkable composition begins in the extruder, but only to a minimal extent. In another embodiment, crosslinking is delayed until the crosslinkable composition is extruded upon the conductor. Crosslinking of the crosslinkable polymeric composition can be initiated and/or accelerated through exposure to humid environment (e.g., ambient conditions or cure in a sauna or water bath). In an embodiment, crosslinking of the crosslinkable composition is initiated and/or accelerated through exposure to moisture.

In an embodiment, the coated conductor is selected from a fiber optic cable, a communications cable (such as a telephone cable, a local area network (LAN) cable, or a small form-factor pluggable (SFP) cable), a power cable, wiring for consumer electronics, a power charger wire for cell phones and/or computers, computer data cords, power cords, appliance wiring material, home interior wiring material, consumer electronic accessory cords, and any combination thereof.

The coated conductor may comprise two or more embodiments disclosed herein.

G. Process

The present disclosure provides a process for moisture curing a silane-functionalized ethylene-based polymer. The process includes (A) providing an aromatic amine-aromatic sulfonic acid salt (AS-ASAS); (B) mixing the aromatic amine-aromatic sulfonic acid salt with a hindered phenol antioxidant to form a catalyst composition; (C) contacting a silane functionalized ethylene-based polymer with the catalyst composition to form a crosslinkable composition; and (D) exposing the crosslinkable composition to moisture cure conditions to form a crosslinked composition.

Moisture cure conditions include the presence of water (e.g., as a bath or humidity present in the environment), and a temperature of from 20° C., or 23° C. to 25° C. to 30° C.

In an embodiment, the (B) mixing the AS-ASAS with a hindered phenol antioxidant to form a catalyst composition and the (C) contacting a silane functionalized ethylene-based polymer with the catalyst composition to form a crosslinkable composition occur simultaneously. In other words, the AS-ASAS, hindered phenol antioxidant, and silane functionalized ethylene-based polymer are simultaneously blended to form the crosslinkable composition.

In an embodiment, the (B) mixing the AS-ASAS with a hindered phenol antioxidant to form a catalyst composition includes forming a masterbatch containing, consisting essentially of, or consisting of (i) the AS-ASAS (such as the AS-ASAS having the Structure (I), with a sulfur to nitrogen molar ratio of 1:1), (ii) the hindered phenol antioxidant, and (iii) a carrier polyolefin. The masterbatch and the carrier polyolefin may be any respective masterbatch (also referred to as a catalyst masterbatch) and carrier polyolefin disclosed herein. In an embodiment, the carrier polyolefin is a blend of EEA copolymer and LDPE.

In an embodiment, the process includes synthesizing the AS-ASAS by mixing the aromatic amine with the aromatic sulfonic acid in an organic solvent or a wax, for a period of from one, or two to three, or four, or five, or six hours at room temperature (23-25° C.). Nonlimiting examples of suitable organic solvent include dichloromethane, toluene, and combinations thereof.

The process may comprise two or more embodiments disclosed herein.

By way of example, and not limitation, some embodiments of the present disclosure will now be described in detail in the following examples.

### Examples

The materials used in the examples are provided in Table 1 below.

TABLE 1
Materials

| Component | Specification | Source |
|---|---|---|
| SI-LINK ™ | ethylene/silane copolymer | The Dow Chemical |
| DFDA-5451 NT | density = 0.922 g/cc; melt index = 1.5 g/10 min | Company |
| DXM-205 | ethylene/ethyl acrylate (EEA) copolymer | The Dow Chemical |
| | 19 wt % ethyl acrylate; melt index = 20 g/10 min; | Company |
| | density = 0.93 g/cc | |
| DXM-446 | low density polyethylene (LDPE); CAS 9002-88-4; | The Dow Chemical |
| | density = 0.92 g/cc; melt index = 2.3 g/10 min | Company |
| IRGANOX ™ 1010 | hindered phenol antioxidant; CAS 6683-19-8; | BASF |
| | pentaerythritol tetrakis(3-(3,5-di-tert-butyl-4- | |
| | hydroxyphenyl)propionate | |
| NACURE ™ B201 | aromatic sulfonic acid; naphthalene sulfonic acid | King Industries, Inc. |
| DBSA | aromatic sulfonic acid; CAS 27176-87-0; | Energy Chemical |
| | dodecylbenzenesulfonic acid (DBSA) | |
| 4- | aromatic sulfonic acid; 4-methylbenzenesulfonic | Shanghai Haohong |
| methylbenzenesulfonic | acid monohydrate, 95% solution; CAS 6192-52-5 | Biomedical |
| acid monohydrate | | Technology Co., Ltd |
| naphthalene-2-sulfonic | aromatic sulfonic acid; naphthalene-2-sulfonic | Shanghai Macklin |
| acid | acid, 98%; CAS 120-18-3 | Biochemical Co., Ltd. |
| trifluoromethanesulfonic | trifluoromethanesulfonic acid, 99%; | Energy Chemical |
| acid | CAS 1493-16-6 | |
| methanesulfonic acid | methanesulfonic acid, 99%; CAS 75-75-2 | Shanghai Macklin |
| | | Biochemical Co., Ltd. |
| naphthalene-1-sulfonic | naphthalene-1-sulfonic acid, 98%; CAS 85-47-2 | China Langchem Inc. |
| acid | | |
| NAUGARD ™ 445 | aromatic amine; CAS 10081-67-1 | Energy Chemical |
| | bis(4-(2-phenylpropan-2-yl)phenyl)amine | |
| di([1,1′-biphenyl]- | aromatic amine; CAS 102113-98-4 | Bide Pharmatech Ltd |
| 4-yl)amine | di([1,1′-biphenyl]-4-yl)amine, 97% | |
| AO 4020 | aromatic amine; N1-(4-methylpentan-2-yl)-N4- | Tianjin Heowns |
| | phenylbenzene-1,4-diamine, 98%; CAS 793-24-8 | Biochem LLC |
| AO 124 | polymerized amine; CAS 26780-96-1 | Bide Pharmatech Ltd |
| | polymerized 1,2-dihydro-2,2,4-trimethylquinoline | |
| | mixture of dimer (50-65 wt %), trimer | |
| | (25-40 wt %), and tetramer (8-15 wt %) | |
| diisobutylamine | diisobutylamine, 99%; CAS 110-96-3 | Merck |
| diisopropylamine | diisopropylamine, 99%; CAS 108-18-9 | Merck |

A. Catalyst Salt Synthesis

The catalyst salts of Table 2 are synthesized by combining 10 mmol amine with 10 mmol acid in a reaction flask that contains 100 mL dichloromethane. For amines containing more than one amino group, the amount of acid within the reaction mixture is varied to achieve the desired stoichiometric ratio between the sulfonic acid and amino groups.

The reaction mixture is stirred for two hours at room temperature (23-25° C.). Then, the solution is evaporated using a rotary evaporator under a reduced pressure of 0.1 MPa at 35° C. for 15 minutes, and the catalyst salt solid product is obtained and dried over a vacuum at room temperature (23-25° C.) for a period of 6 hours.

The amine, acid, and resulting catalyst salts are provided in Table 2. As shown in Table 2, Ex Salt 1-4, Ex Salt 7, Ex Salt 9, Ex Salt 11, and Ex Salt 15 each is an AA-ASAS.

B. Catalyst Salt Masterbatch Preparation and Pelletization

DXM-205 (EEA copolymer) and DXM-446 (LDPE) are fed in equal amounts (i.e., a 1:1 weight ratio) into a Brabender mixer set at a temperature of 120° C. and a rotator speed of 15 rotations per minute (rpm). Then, one of the catalyst salts of Table 2 and IRGANOX™ 1010 (hindered phenol antioxidant) are fed into the mixer, and the masterbatch composition is mixed for three minutes at a temperature of 120° C. and a rotator speed of 50 rpm.

After mixing, the Catalyst Salt Masterbatch is fed into a Brabender single-screw extruder set at 120° C., and pelletized.

Each Catalyst Salt Masterbatch contains 4.4 mmol/100 g sulfonic groups, based on the respective catalyst salt masterbatch. The composition of each Catalyst Salt Masterbatch is provided below in Table 3.

Catalyst Salt Masterbatches of Table 3 are measured for isobutylene by HSGC or by GC, after Sample Preparation Method 1 or Sample Preparation Method 2 as described above in the Test Methods section. The results are provided in Tables 4A and 4B below. In the tables, “NM” indicates a value was not measured.

As shown in Table 4B, the catalyst master batch MB21 (which contains DBSA) generates two times the amount of isobutylene than catalyst master batch MB19 (which contains naphthalene sulfonic acid), as measured by GC and Sample Preparation Method 2. This suggests that DBSA tends to decompose hindered phenol antioxidants at a faster rate than naphthalene sulfonic acid. However, as shown in Table 4A, catalyst master batch MB2 (which contains Ex Salt 2, an AA-ASAS formed using DBSA and NAUGARD™ 445), surprisingly generates much lower isobutylene compared to catalyst master batch MB19 (which contains naphthalene sulfonic acid). Not wishing to be bound by any particular theory, it is believed that at least 50% isobutylene reduction can be achieved by using the aromatic amine-aromatic sulfonic acid salt instead of corresponding sulfonic acid.

TABLE 2
Catalyst Salts

| | | | | Molar |
|---|---|---|---|---|
| | | | | ratio |
| Cata- | | | | sulfur |
| lyst | | | | to |
| Salt | | | | nitro- |
| No. | Amine | Acid | Catalyst Salt Structure | gen |
| Ex | NAUGARD ™ | 4-methyl- | Structure (IV) of Table C | 1:1 |
| Salt 1 | 445 | benzene | | |
| | | sulfonic | | |
| | | acid | | |
| Ex | NAUGARD ™ | DBSA | Structure (V) of Table C | 1:1 |
| Salt 2 | 445 | | | |
| Ex | NAUGARD ™ | naphthalene- | Structure (VI) of Table C | 1:1 |
| Salt 3 | 445 | 1- | | |
| | | sulfonic | | |
| | | acid | | |
| Ex | NAUGARD ™ | naphthalene- | Structure (VII) of Table C | 1:1 |
| Salt 4 | 445 | 2- | | |
| | | sulfonic | | |
| | | acid | | |
| CS Salt 5 | NAUGARD ™ 445 | trifluoro- methane- sulfonic acid | 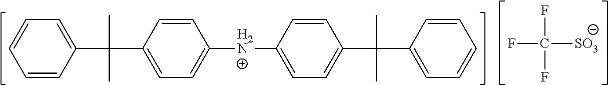 | 1:1 |
| CS Salt 6 | NAUGARD ™ 445 | mathane- sulfonic acid | 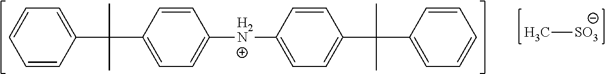 | 1:1 |
| Ex | di([1,1′- | naphthalene- | Structure (VIII) of Table C | 1:1 |
| Salt 7 | biphenyl]-4- | 1- | | |
| | yl)amine | sulfonic | | |
| | | acid | | |
| CS Salt 8 | di([1,1′- biphenyl]-4- yl)amine | methane- sulfonic acid | 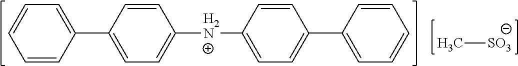 | 1:1 |
| Ex | AO 4020 | 4-methyl- | Structure (IX) of Table C | 1:1 |
| Salt 9 | | benzene | | |
| | | sulfonic | | |
| | | acid | | |
| CS Salt 10 | AO 4020 | 4-methyl- benzene- sulfonic acid | 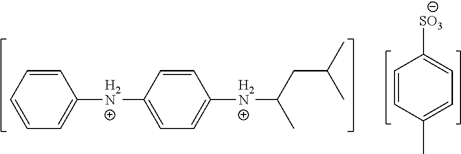 | 2:1 |
| Ex | AO 4020 | naphthalene- | Structure (X) of Table C | 1:1 |
| Salt 11 | | 1- | | |
| | | sulfonic | | |
| | | acid | | |
| CS Salt 12 | AO 4020 | naphthalene- 1- sulfonic acid | 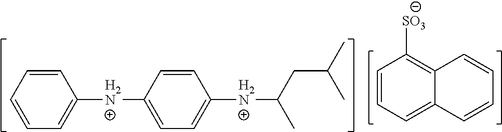 | 2:1 |
| CS Salt 13 | AO 4020 | Methyl Sulfonic Acid | 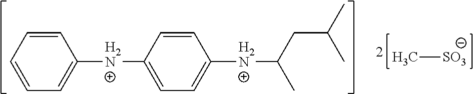 | 1:1 |
| CS Salt 14 | AO 4020 | Methyl Sulfonic Acid | 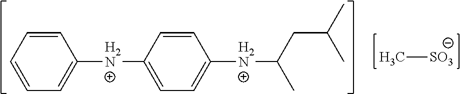 | 2:1 |
| Ex | AO 4020 | naphthalene- | Structure (XI) of Table C | 1:1 |
| Salt 15 | | 1- | | |
| | | sulfonic | | |
| | | acid | | |
| CS Salt 16 | diisopropyl- amine | naphthalene- 1- sulfonic acid | 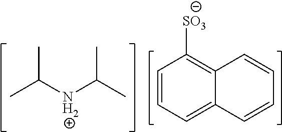 | 1:1 |
| CS Salt 17 | diisobutyl- amine | naphthalene- 1- sulfonic acid | 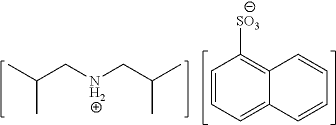 | 1:1 |
| CS Salt 18 | AO 124 | naphthalene- 1- sulfonic acid | 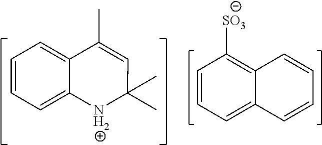 | 1:1 |

TABLE 3
Catalyst Salt Masterbatches*

| | MB | MB | MB | MB | MB | MB | MB | MB | MB | MB | MB |
|---|---|---|---|---|---|---|---|---|---|---|---|
| | 1 | 2 | 3 | 4 | 5 | 6 | 7 | 8 | 9 | 10 | 11 |
| DXM-205 | 47.75 | 47.42 | 47.69 | 47.68 | 47.92 | 47.92 | 47.86 | 48.11 | 47.68 | 48.06 | 47.53 |
| (EEA) | | | | | | | | | | | |
| DXM-446 | 47.75 | 47.42 | 47.69 | 47.68 | 47.92 | 47.92 | 47.86 | 48.11 | 47.68 | 48.06 | 47.53 |
| (LDPE) | | | | | | | | | | | |
| IRGANOX ™ | 1.97 | 1.97 | 1.97 | 1.97 | 1.97 | 1.97 | 1.97 | 1.97 | 1.97 | 1.97 | 1.97 |
| 1010 | | | | | | | | | | | |
| Ex Salt 1 | 2.52 | — | — | — | — | — | — | — | — | — | — |
| Ex Salt 2 | — | 3.20 | — | — | — | — | — | — | — | — | — |
| Ex Salt 3 | — | — | 2.65 | — | — | — | — | — | — | — | — |
| Ex Salt 4 | — | — | — | 2.68 | — | — | — | — | — | — | — |
| CS Salt 5 | — | — | — | — | 2.19 | — | — | — | — | — | — |
| CS Salt 6 | — | — | — | — | — | 2.19 | — | — | — | — | — |
| Ex Salt 7 | — | — | — | — | — | — | 2.31 | — | — | — | — |
| CS Salt 8 | — | — | — | — | — | — | — | 1.82 | — | — | — |
| Ex Salt 9 | — | — | — | — | — | — | — | — | 2.67 | — | — |
| CS Salt 10 | — | — | — | — | — | — | — | — | — | 1.92 | — |
| Ex Salt 11 | — | — | — | — | — | — | — | — | — | — | 2.98 |
| CS Salt 12 | — | — | — | — | — | — | — | — | — | — | — |
| CS Salt 13 | — | — | — | — | — | — | — | — | — | — | — |
| CS Salt 14 | — | — | — | — | — | — | — | — | — | — | — |
| Ex Salt 15 | — | — | — | — | — | — | — | — | — | — | — |
| CS Salt 16 | — | — | — | — | — | — | — | — | — | — | — |
| CS Salt 17 | — | — | — | — | — | — | — | — | — | — | — |
| CS Salt 18 | — | — | — | — | — | — | — | — | — | — | — |
| NACURE ™ | — | — | — | — | — | — | — | — | — | — | — |
| B201 | | | | | | | | | | | |
| NAUGARD ™ | — | — | — | — | — | — | — | — | — | — | — |
| 445 | | | | | | | | | | | |
| DBSA | — | — | — | — | — | — | — | — | — | — | — |
| Total wt % | 100 | 100 | 100 | 100 | 100 | 100 | 100 | 100 | 100 | 100 | 100 |
| | MB | MB | MB | MB | MB | MB | MB | MB | MB | MB | MB |
| | 12 | 13 | 14 | 15 | 16 | 17 | 18 | 19 | 20 | 21 | 22 |
| DXM-205 | 47.98 | 48.02 | 48.02 | 47.57 | 48.34 | 48.28 | 48.20 | 47.61 | 47.74 | 48.305 | 47.43 |
| (EEA) | | | | | | | | | | | |
| DXM-446 | 47.98 | 48.02 | 48.02 | 47.57 | 48.34 | 48.28 | 48.20 | 47.61 | 47.74 | 48.305 | 47.43 |
| (LDPE) | | | | | | | | | | | |
| IRGANOX ™ | 1.97 | 1.97 | 1.97 | 1.97 | 1.97 | 1.97 | 1.97 | 1.97 | 1.97 | 1.97 | 1.97 |
| 1010 | | | | | | | | | | | |
| Ex Salt 1 | — | — | — | — | — | — | — | — | — | — | — |
| Ex Salt 2 | — | — | — | — | — | — | — | — | — | — | — |
| Ex Salt 3 | — | — | — | — | — | — | — | — | — | — | — |
| Ex Salt 4 | — | — | — | — | — | — | — | — | — | — | — |
| CS Salt 5 | — | — | — | — | — | — | — | — | — | — | — |
| CS Salt 6 | — | — | — | — | — | — | — | — | — | — | — |
| Ex Salt 7 | — | — | — | — | — | — | — | — | — | — | — |
| CS Salt 8 | — | — | — | — | — | — | — | — | — | — | — |
| Ex Salt 9 | — | — | — | — | — | — | — | — | — | — | — |
| CS Salt 10 | — | — | — | — | — | — | — | — | — | — | — |
| Ex Salt 11 | — | — | — | — | — | — | — | — | — | — | — |
| CS Salt 12 | 2.08 | — | — | — | — | — | — | — | — | — | — |
| CS Salt 13 | — | 2.00 | — | — | — | — | — | — | — | — | — |
| CS Salt 14 | — | — | 2.00 | — | — | — | — | — | — | — | — |
| Ex Salt 15 | — | — | — | 2.89 | — | — | — | — | — | — | — |
| CS Salt 16 | — | — | — | — | 1.35 | — | — | — | — | — | — |
| CS Salt 17 | — | — | — | — | — | 1.47 | — | — | — | — | — |
| CS Salt 18 | — | — | — | — | — | — | 1.64 | — | — | — | — |
| NACURE ™ | — | — | — | — | — | — | — | 2.80 | 2.80 | — | — |
| B201 | | | | | | | | | | | |
| NAUGARD ™ | — | — | — | — | — | — | — | — | 1.75 | — | 1.75 |
| 445 | | | | | | | | | | | |
| DBSA | — | — | — | — | — | — | — | — | — | 1.42 | 1.42 |
| Total wt % | 100 | 100 | 100 | 100 | 100 | 100 | 100 | 100 | 100 | 100 | 100 |

*Amounts in Table 3 are in weight percent, based on the total weight of the Catalyst Salt Masterbatch.
CS = Comparative Sample

TABLE 4A
Isobutylene Measurement by HSGC and Sample Preparation Method 1.

| | MB1 | MB2 | MB3 | MB5 | MB15 | MB19 |
|---|---|---|---|---|---|---|
| Peak Area(HSGC)/Weight, g⁻¹ | 2.58E+06 | 4.57E+06 | 1.60E+06 | 2.45E+07 | 6.06E+05 | 8.19E+06 |
| Peak Area (HSGC) per mol Sulfur, | 5.86E+10 | 1.04E+11 | 3.63E+10 | 5.56E+11 | 1.38E+10 | 1.86E+11 |
| mol⁻¹ | | | | | | |

TABLE 4B
Isobutylene Measurement by HSGC or GC, and Sample Preparation Method 2.

| | | | | | | |
|---|---|---|---|---|---|---|
| MB4 | MB7 | MB8 | MB11 | MB13 | MB19 | MB21 |

HSGC Measurement

| | | | | | | | |
|---|---|---|---|---|---|---|---|
| Peak Area (HSGC)/ | 6.56E+04 | 7.13E+04 | 2.70E+05 | 5.58E+04 | 8.05E+04 | 1.02E+06 | NM |
| Weight, g⁻¹ | | | | | | | |
| Peak Area (HSGC) per | 1.49E+09 | 1.62E+09 | 6.13E+09 | 1.27E+09 | 1.83E+09 | 2.32E+10 | NM |
| mol Sulfur, mol⁻¹ | | | | | | | |

GC Measurement

| | | | | | | | |
|---|---|---|---|---|---|---|---|
| Peak Area (GC)/Weight, | NM | NM | NM | NM | NM | 1.77E+06 | 3.53E+06 |
| g⁻¹ | | | | | | | |
| Peak Area (GC) per mol | NM | NM | NM | NM | NM | 4.02E+10 | 8.02E+10 |
| Sulfur, mol⁻¹ | | | | | | | |

C. Composition Preparation

SI-LINK™ DFDA-5451 NT (ethylene/silane copolymer) pellets and Catalyst Salt Masterbatch (of Table 3) pellets are dry blended to form a dry blend with 95 wt % SI-LINK™ DFDA-5451 NT and 5 wt % Catalyst Salt Masterbatch, based on the total weight of the dry blend. The dry blend is fed into a Brabender single-screw extruder set at 160° C., and are mixed until the composition is in a molten form. Then, the composition is extruded into a tape having a thickness of 1 mm.

At least one tape for each sample is placed into a water bath set at a temperature of 90° C. Samples are tested for hot creep after sitting in the water bath for 1 hour, 3 hours, and 6 hours. Sample compositions that are crosslinkable undergo cure in the water bath.

At least one tape for each sample is placed on a workbench in ambient environment (room temperature of 23-25° C., 50% relative humidity). Samples are tested for hot creep after sitting in ambient environment for 69 hours, 90 hours, 100 hours, 168 hours, and 230 hours. Sample compositions that are crosslinkable undergo cure in the ambient environment.

The composition of each sample, and the results are provided below in Table 5.

As shown in Table 5, CS 6, CS 8, CS 13, and CS 14 each contains (A) ethylene/silane copolymer (SI-LINK™ DFDA-5451 NT), (B) hindered phenol antioxidant (IRGANOX™ 1010), and (C) an aromatic amine-linear sulfonic acid salt (CS Salt 6, CS Salt 8, CS Salt 13, and CS Salt 14). CS 6, CS 8, CS 13, and CS 14 each lacks an aromatic amine-aromatic sulfonic acid salt. CS 6, CS 8, CS 13, and CS 14 each broke during hot creep testing at all time lengths-indicating that the compositions are not cured. Consequently, CS 6, CS 8, CS 13, and CS 14 are not moisture crosslinkable compositions.

TABLE 5
Compositions

| | Ex | Ex | Ex | Ex | CS | CS | Ex | CS | Ex | CS | Ex |
|---|---|---|---|---|---|---|---|---|---|---|---|
| | 1 | 2 | 3 | 4 | 5 | 6 | 7 | 8 | 9 | 10 | 11 |
| DFDA- | 95 | 95 | 95 | 95 | 95 | 95 | 95 | 95 | 95 | 95 | 95 |
| 5451 NT | | | | | | | | | | | |
| MB1 | 5 | — | — | — | — | — | — | — | — | — | — |
| MB2 | — | 5 | — | — | — | — | — | — | — | — | — |
| MB3 | — | — | 5 | — | — | — | — | — | — | — | — |
| MB4 | — | — | — | 5 | — | — | — | — | — | — | — |
| MB5 | — | — | — | — | 5 | — | — | — | — | — | — |
| MB6 | — | — | — | — | — | 5 | — | — | — | — | — |
| MB7 | — | — | — | — | — | — | 5 | — | — | — | — |
| MB8 | — | — | — | — | — | — | — | 5 | — | — | — |
| MB9 | — | — | — | — | — | — | — | — | 5 | — | — |
| MB10 | — | — | — | — | — | — | — | — | — | 5 | — |
| MB11 | — | — | — | — | — | — | — | — | — | — | 5 |
| MB12 | — | — | — | — | — | — | — | — | — | — | — |
| MB13 | — | — | — | — | — | — | — | — | — | — | — |
| MB14 | — | — | — | — | — | — | — | — | — | — | — |
| MB15 | — | — | — | — | — | — | — | — | — | — | — |
| MB16 | — | — | — | — | — | — | — | — | — | — | — |
| MB17 | — | — | — | — | — | — | — | — | — | — | — |
| MB18 | — | — | — | — | — | — | — | — | — | — | — |
| MB19 | — | — | — | — | — | — | — | — | — | — | — |
| MB20 | — | — | — | — | — | — | — | — | — | — | — |
| MB21 | — | — | — | — | — | — | — | — | — | — | — |
| MB22 | — | — | — | — | — | — | — | — | — | — | — |
| Total wt % | 100 | 100 | 100 | 100 | 100 | 100 | 100 | 100 | 100 | 100 | 100 |

Hot Creep (%)

| | | | | | | | | | | | | |
|---|---|---|---|---|---|---|---|---|---|---|---|---|
| Water | 1 hr | 157 | NM | 40 | 120 | NM | B | 103 | B | NM | B | NM |
| Bath | 3 hr | 108 | 32 | 32 | 67 | 82 | B | 68 | B | NM | B | 127 |
| Ambient | 6 hr | NM | NM | NM | NM | 72 | B | NM | B | 75 | B | 145 |
| Env.¹ | 69 hr | NM | 67 | NM | NM | NM | B | NM | B | NM | B | NM |
| | 90 hr | NM | 70 | 105 | NM | 115 | B | NM | B | NM | B | NM |
| | 100 hr | 130 | NM | NM | NM | NM | B | NM | B | NM | B | NM |
| | 168 hr | 83 | 55 | 85 | NM | NM | B | NM | B | NM | B | NM |
| | 230 hr | 53 | NM | NM | NM | 60 | B | NM | B | NM | B | NM |

| | CS | CS | CS | Ex | CS | CS | CS | CS | CS | CS | CS |
|---|---|---|---|---|---|---|---|---|---|---|---|
| | 12 | 13 | 14 | 15 | 16 | 17 | 18 | 19 | 20 | 21 | 22 |
| DFDA- | 95 | 93 | 95 | 95 | 95 | 95 | 95 | 95 | 95 | 95 | 95 |
| 5451 NT | | | | | | | | | | | |
| MB1 | — | — | — | — | — | — | — | — | — | — | — |
| MB2 | — | — | — | — | — | — | — | — | — | — | — |
| MB3 | — | — | — | — | — | — | — | — | — | — | — |
| MB4 | — | — | — | — | — | — | — | — | — | — | — |
| MB5 | — | — | — | — | — | — | — | — | — | — | — |
| MB6 | — | — | — | — | — | — | — | — | — | — | — |
| MB7 | — | — | — | — | — | — | — | — | — | — | — |
| MB8 | — | — | — | — | — | — | — | — | — | — | — |
| MB9 | — | — | — | — | — | — | — | — | — | — | — |
| MB10 | — | — | — | — | — | — | — | — | — | — | — |
| MB11 | — | — | — | — | — | — | — | — | — | — | — |
| MB12 | 5 | — | — | — | — | — | — | — | — | — | — |
| MB13 | — | 5 | — | — | — | — | — | — | — | — | — |
| MB14 | — | — | 5 | — | — | — | — | — | — | — | — |
| MB15 | — | — | — | 5 | — | — | — | — | — | — | — |
| MB16 | — | — | — | — | 5 | — | — | — | — | — | — |
| MB17 | — | — | — | — | — | 5 | — | — | — | — | — |
| MB18 | — | — | — | — | — | — | 5 | — | — | — | — |
| MB19 | — | — | — | — | — | — | — | 5 | — | — | — |
| MB20 | — | — | — | — | — | — | — | — | 5 | — | — |
| MB21 | — | — | — | — | — | — | — | — | — | 5 | — |
| MB22 | — | — | — | — | — | — | — | — | — | — | 5 |
| Total wt % | 100 | 100 | 100 | 100 | 100 | 100 | 100 | 100 | 100 | 100 | 100 |

Hot Creep (%)

| | | | | | | | | | | | | |
|---|---|---|---|---|---|---|---|---|---|---|---|---|
| Water | 1 hr | B | B | B | NM | B | B | B | 38 | 25 | <70 | <43 |
| Bath | 3 hr | B | B | B | NM | B | B | B | 18 | NM | NM | NM |
| Ambient | 6 hr | B | B | B | 73 | B | B | B | NM | NM | NM | NM |
| Env.¹ | 69 hr | B | B | B | NM | B | B | B | 75 | 85² | 48³ | 75³ |
| | 90 hr | B | B | B | NM | B | B | B | NM | NM | NM | NM |
| | 100 hr | B | B | B | NM | B | B | B | 62 | NM | NM | NM |
| | 168 hr | B | B | B | 130 | B | B | B | NM | NM | NM | NM |
| | 230 hr | B | B | B | NM | B | B | B | NM | NM | NM | NM |

*Amounts in Table 5 are in weight percent, based on the total weight of the crosslinkable composition.
CS = Comparative Sample
³Measured at 71 hours
B = sample broke, including the composition is not cured
¹Hot Creep after curing in ambient environment
²Measured at 72 hours

CS 16 and CS 17 each contains (A)ethylene/silane copolymer (SI-LINK™ DFDA-5451 NT), (B) hindered phenol antioxidant (IRGANOX™ 1010), and (C) a linear amine-aromatic sulfonic acid salt (CS Salt 16 and CS Salt 17). CS 16 and CS 17 each lacks an aromatic amine-aromatic sulfonic acid salt. CS 16 and CS 17 each broke during hot creep testing at all time lengths-indicating that the compositions are not cured. Consequently, CS 16 and CS 17 are not moisture crosslinkable compositions.

CS 18 contains (A) ethylene/silane copolymer (SI-LINK™ DFDA-5451 NT), (B) hindered phenol antioxidant (IRGANOX™ 1010), and (C) a polymeric aromatic amine-aromatic sulfonic acid salt (CS Salt 18). CS 18 lacks a non-polymeric an aromatic amine-aromatic sulfonic acid salt. CS 18 broke during hot creep testing at all time lengths-indicating that the composition is not cured. Consequently, CS 18 is not a moisture crosslinkable composition.

CS 19 contains (A) ethylene/silane copolymer (SI-LINK™ DFDA-5451 NT), (B) hindered phenol antioxidant (IRGANOX™ 1010), and (C) aromatic sulfonic acid (NACURE™ B201). CS 19 lacks an aromatic amine-aromatic sulfonic acid salt. As shown in Tables 4A and 4B, the catalyst masterbatch contained in CS 19 (MB19) exhibits an isobutylene generation peak area of greater than 6,000,000 per gram (8,190,000 per gram) measured by HSGC and Sample Preparation Method 1. Consequently, CS 19 is dangerous to produce and handle.

CS 10, CS 12, and CS 14 each contains (A) ethylene/silane copolymer (SI-LINK™ DFDA-5451 NT), (B) hindered phenol antioxidant (IRGANOX™ 1010), and (C) an aromatic amine-aromatic sulfonic acid salt that has a molar ratio of sulfur to nitrogen greater than 1.3:1 (2:1)(CS Salt 10, CS Salt 12, and CS Salt 14). CS 10, CS 12, and CS 14 each broke during hot creep testing at all time lengths-indicating that the compositions are not cured. Consequently, CS 10, CS 12, and CS 14 are not moisture crosslinkable compositions.

In contrast, a composition (Ex 1-Ex 4, Ex 7, Ex 9, Ex 11, and Ex 15) containing (A) ethylene/silane copolymer (SI-LINK™ DFDA-5451 NT), (B) hindered phenol antioxidant (IRGANOX™ 1010), and (C) an aromatic amine-aromatic sulfonic acid salt that has a molar ratio of sulfur to nitrogen greater than 1:1 surprisingly exhibits suitable hot creep (e.g., a hot creep of 130% or less after gaining in ambient environment for 168 hours)—indicating that the compositions are crosslinkable—while also exhibiting safe levels of isobutylene generation (e.g., an isobutylene generation peak area of less than 6,000,000 per gram measured by HSGC and Sample Preparation Method 1.

It is specifically intended that the present disclosure not be limited to the embodiments and illustrations contained herein, but include modified forms of those embodiments including portions of the embodiments and combinations of elements of different embodiments as come within the scope of the following claims.

1. A composition comprising:
(A) a silane functionalized ethylene-based polymer;
(B) a hindered phenol antioxidant; and
(C) an aromatic amine-aromatic sulfonic acid salt.

2. The composition of claim 1, wherein the aromatic amine-aromatic sulfonic acid salt has a Structure (I) 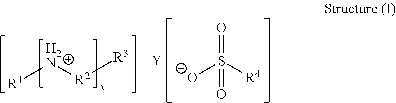
wherein Y is an integer from 1 to 3;
R¹ is selected from the group consisting of an aryl group, a substituted aryl group, an alkyl group, or a substituted alkyl group;
R² is selected from the group consisting of an aryl group, and a substituted aryl group;
R³ is selected from the group consisting of an aryl group, a substituted aryl group, an alkyl group, a substituted alkyl group, or hydrogen;
R⁴ is selected from the group consisting of an aryl group, and a substituted aryl group; and
X is an integer from 1 to 4.

3. The composition of claim 1, wherein the aromatic amine-aromatic sulfonic acid salt has a molar ratio of sulfur to nitrogen of 1:1.

4. The composition of claim 1, wherein the silane functionalized polyolefin is selected from the group consisting of a silane-grafted ethylene-based polymer and an ethylene/silane copolymer.

5. The composition of claim 1, comprising
(A) from 30 wt % to 99 wt % silane functionalized ethylene-based polymer;
(B) from 0.03 wt % to 1 wt % hindered phenol antioxidant; and
(C) from 0.05 wt % to 5 wt % aromatic amine-aromatic sulfonic acid salt.

6. The composition of claim 1, wherein the composition is crosslinkable.

7. The composition of claim 1, wherein the composition has a hot creep after curing in a water bath at 90° C. for 3 hours of less than 100%.

8. The composition of claim 1, wherein the composition has a hot creep after curing in ambient environment for 168 hours of less than 100%.

9. The composition of claim 1, wherein the composition exhibits an isobutylene reduction of at least 50% compared to the same composition containing the aromatic sulfonic acid of the aromatic amine-aromatic sulfonic acid salt, instead of the salt.

10. A coated conductor comprising
a conductor; and
a coating on the conductor, the coating comprising the composition of claim 9.

11. A process for moisture curing a silane functionalized ethylene-based polymer comprising:
(A) providing an aromatic amine-aromatic sulfonic acid salt;
(B) mixing the aromatic amine-aromatic sulfonic acid salt with a hindered phenol antioxidant to form a catalyst composition;
(C) contacting a silane functionalized ethylene-based polymer with the catalyst composition to form a crosslinkable composition; and
(D) exposing the crosslinkable composition to moisture cure conditions to form a crosslinked composition.

12. The process of claim 11, wherein the (B) mixing and the (C) contacting occur simultaneously.

13. The process of claim 11, wherein the (B) mixing comprises forming a masterbatch comprising
the aromatic amine-aromatic sulfonic acid salt;
the hindered phenol antioxidant; and
a carrier polyolefin.

14. The process of claim 11 comprising (A) providing the aromatic amine-aromatic sulfonic acid salt having a Structure (I) 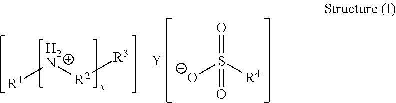
wherein Y is an integer from 1 to 3;
R¹ is selected from the group consisting of an aryl group, a substituted aryl group, an alkyl group, or a substituted alkyl group;
R² is selected from the group consisting of an aryl group, and a substituted aryl group;
R³ is selected from the group consisting of an aryl group, a substituted aryl group, an alkyl group, a substituted alkyl group, or hydrogen;
R⁴ is selected from the group consisting of an aryl group, and a substituted aryl group; and
X is an integer from 1 to 4.

15. The process of claim 11 comprising (A) providing the aromatic amine-aromatic sulfonic acid salt having a molar ratio of sulfur to nitrogen of 1:1.
